(19) United States
(12) Patent Application Publication
(10) Pub. No.: US 2024/0309167 A1
(43) Pub. Date: Sep. 19, 2024

(54) CATALYTIC UPCYCLING PROCESS

(71) Applicant: Oxford University Innovation Limited, Oxford (GB)

(72) Inventors: Tiancun XIAO, Oxford (Oxfordshire) (GB); Peter P. EDWARDS, Oxford (Oxfordshire) (GB); Xiangyu JIE, Oxford (Oxfordshire) (GB)

(21) Appl. No.: 18/276,891

(22) PCT Filed: Feb. 16, 2022
(86) PCT No.: PCT/GB2022/050407

§ 371 Date: Aug. 11, 2023

(30) Foreign Application Priority Data
Feb. 17, 2021 (GB) 2102240.5

(51) Int. Cl. C08J 11/16; B01J 29/40

(52) U.S. Cl. CPC C08J 11/16; B01J 29/40; C08J 2323/06; C08J 2323/12

(57) ABSTRACT

Provided is a process for producing one or more aromatic compounds comprising exposing a feed composition comprising at least one plastic to microwave radiation in the presence of a solid catalyst composition, wherein the solid catalyst composition comprises a solid acid catalyst and a carbon source. Also provided is a solid catalyst composition suitable for use in said process and for upcycling plastic.

### INTRODUCTION

The present invention relates to a process for converting plastic to useful chemicals, in particular aromatic compounds, such as benzene, toluene and xylene mixtures. The process can be used to recycle waste plastic. The process of the present invention utilizes a single step, microwave-initiated catalytic process for producing aromatic compounds from a feed stream comprising plastic using a bifunctional solid catalyst composition.

### BACKGROUND OF THE INVENTION

The ever-increasing production and use of plastics over the last half a century has created a huge environmental problem for the world. Currently, most of the 4.9 billion tonnes of plastics produced to date will end up in landfills or the natural environment, and this figure is expected to increase to around 12 billion tonnes by 2050 (Geyer, R., Jambeck, J. R. & Law, K. L. Production, use, and fate of all plastics ever made. Science advances 3, e1700782 (2017)).

Plastics are incredibly useful in an enormous range of applications because they are light, versatile, cheap and nearly indestructible. These properties make them widely used for the packaging that keeps foods fresh, to the sterile materials used in medical applications, to the cheap, lightweight parts that go into many of our affordable, durable goods. However, their robust nature comes at a cost. Plastics are slow to break down naturally and they are very difficult to recycle chemically. These factors have contributed to the present global epidemic of plastic waste.

Polyolefins such h as high density polyethylene (HDPE), low density polyethylene (LDPE) and polypropylene (PP), are the most common plastics and account for around half of the overall production. In order to minimize plastic waste in landfills, several recycling and upcycling methods have been proposed, which range from primary routes of direct recycling to quaternary routes of energy valorization (Lopez, G., Artetxe, M., Amutio, M., Bilbao, J. & Olazar, M. Thermochemical routes for the valorization of waste polyolefinic plastics to produce fuels and chemicals. A review. Renewable and Sustainable Energy Reviews 73, 346-368 (2017)). However, limited success has been achieved in the development of closed-loop life cycles for synthetic plastics by these methods.

Chemical recycling by depolymerisation can recover the virgin monomers. However, the thermochemical routes requires prohibitive amounts of energy for polyolefins recovery, namely, low density polyethylene (LDPE), high density polyethylene (HDPE) and polypropylene (PP). Controlled partial depolymerisation could produce more valuable chemicals such as aromatics from plastics waste, although few such processes have yet been developed (Zhang, Fan, et al. “Polyethylene upcycling to long-chain alkylaromatics by tandem hydrogenolysis/aromatization.” Science 23 Oct. 2020, Vol. 370, Issue, 6515, pp. 437-441).

The depolymerisation of PE and PP by pyrolysis usually generates a wide range of complex, low value mixtures of gaseous and liquid hydrocarbons, and char. However, the production of low value alkane products is unlikely to recoup the costs of recovery, separation, and processing using large amounts of a co-reactant (H₂ or liquid alkanes, respectively) (Zhang, Fan, et al., supra.). Thus, higher value petrochemicals, such as aromatics, are more attractive target products from the partial depolymerization of plastics. Aromatic compounds have wide application in fuels (such as diesel and gasoline) but are also precursors for polymers and chemical intermediates.

More specifically, benzene, toluene, xylenes and naphthalenes are valuable materials for a large number of applications. Mixtures of such compounds can be found in aromatic fuels, including gasoline. Benzene may further be used as chemical intermediate, e.g. in the production of ethylbenzene, cumene and cyclohexane. Toluene has found application as a solvent, e.g. for paints, printing ink and glues. It is also used as chemical intermediate in the preparation of toluene diisocyanate, which is a starting material for the production of polyurethane foams. Further it may be used in its disproportionation to benzene and xylenes. p-xylene is used in the preparation of terephthalic acid, which is a monomer for several plastics, such as aramid and polyesters, such as polyethylene terephthalate (PET). o-xylene is mainly used in the production of plasticizers for PVC. The main market for naphthalene resides in the preparation of phthalic acid.

Conventional routes to aromatics, such as BTX and linear alkylaromatics, are via refinery processes of fossil fuel resources and involve energy intensive processes such as steam cracking.

There have been a number of early reports on the catalytic pyrolysis of plastics which occurs at temperatures in excess of 500° C. and provides only moderate yields of aromatics and large amounts of low-value gases (Lopez et al., supra).

WO 2020/2047707 A1 describes a 2-step thermal process wherein plastic is subjected to pyrolysis at high temperature (600° C. to 1000° C.) to produce vapours which are then cooled slightly and subjected to aromatisation at 450° C. to 700° C. in a separate catalytic step. The resulting product stream contains less than 45 wt. % of BTX relative to the plastic feed as well as numerous by-products including carbon dioxide, carbon monoxide, olefins and low molecular weight alkanes.

WO 2020/231488 A1 describes a thermo-catalytic pyrolysis carried out at 500° C. to 650° C. of a feed comprising plastic and a coke forming material over a solid catalyst to produce coke and volatile products. The product stream comprises aromatics, such as BTX, as well as olefins, low molecular weight alkanes, hydrogen, carbon dioxide and carbon monoxide. The yield of BTX is about 50 wt. %.

US 2014/0228606 A1 describes the pyrolysis of plastic over a mixed zeolite/FCC catalyst at a temperature of 600° C. to 700° C. to yield a mixture of olefins and aromatics. Generally, the yield of the aromatics is less than 35 wt. %.

New methods for upcycling of plastics to aromatic compounds are needed, which provide good product yields and selectivity, in order to be of significant benefit to post-consumer waste plastics life cycle management.

### SUMMARY OF THE INVENTION

Provided herein in is a simple, compact and rapid microwave-initiated catalytic method for the efficient upcycling of various plastics into high value aromatic compounds, in particular benzene, toluene and xylene isomers (such as BTX). The process proceeds in high yield and selectivity using an innovative solid catalyst composition. The catalyst composition designed for this process comprises a carbon source and solid acid catalyst and is in general inexpensive and abundant.

In one aspect, provided herein is a process for producing one or more aromatic compounds comprising exposing a feed composition comprising at least one plastic to microwave radiation in the presence of a solid catalyst composition, wherein the solid catalyst composition comprises a solid acid catalyst and a carbon source.

In another aspect, provided herein is a solid catalyst composition comprising a solid acid catalyst in admixture with a carbon source.

In another aspect, provided herein is the use of a solid catalyst composition comprising a solid acid catalyst in admixture with a carbon source for upcycling plastic and/or the production of aromatic compounds.

Preferred, suitable, and optional features of any one particular aspect of the present invention are also preferred, suitable, and optional features of any other aspect.

### BRIEF DESCRIPTION OF THE DRAWINGS

FIG. 1 shows the GC-MS total ion chromatogram (TIC) of the liquid products from PE over a 5:95 CBs/ZSM-5 catalyst composition wherein the PE to catalyst ratio is 1:1.

FIG. 2 shows the GC-MS total ion chromatogram (TIC) of the liquid products from PE over the 5:95 CBs/ZSM-5 catalyst composition wherein the PE to catalyst ratio is 2:1.

FIG. 3 shows the GC-MS total ion chromatogram (TIC) of the liquid products from PE over the 5:95 CBs/ZSM-5 catalyst composition wherein the PE to catalyst ratio is 3:1.

FIG. 4 shows the effect of different mixing ratios of plastic and catalyst composition on gas and liquid yields in wt. % relative to the mass of plastic.

FIG. 5 shows the GC-MS total ion chromatogram (TIC) of the liquid products from PP over the 5:95 CBs/ZSM-5 catalyst composition wherein the PP to catalyst ratio is 1:1.

FIGS. 6a-6e show the GC-MS total ion chromatogram (TIC) of the liquid products from PE over recycled 5:95 CBs/ZSM-5 catalyst composition for cycles 1 to 5 respectively, wherein the PE to catalyst ratio is 2:1.

FIGS. 7a-7e show the GC-MS total ion chromatogram (TIC) of the liquid products from PP over recycled 5:95 CBs/ZSM-5 catalyst composition for cycles 1 to 5 respectively, wherein the PP to catalyst ratio is 2:1.

FIGS. 8a-8f show the GC-MS total ion chromatogram (TIC) of the liquid products from PE over various CBs/ZSM-5 catalyst composition wherein the PE to catalyst ratio is 2:1. FIG. 8a—100% CBs; FIG. 8b—CBs:ZSM-5=2:98; FIG. 8c—CBs:ZSM-5=5:95; FIG. 8d—CBs:ZSM-5=10:90; FIG. 8e—CBs:ZSM-5=20:80; FIG. 8f—100% ZSM-5.

FIGS. 9a-9d show the GC-MS total ion chromatogram (TIC) of the liquid products from PE over various CBs/ZSM-5 catalyst composition wherein the zeolite has various Si:Al and wherein the PE to catalyst ratio is 2:1. FIG. 9a—Si:Al=18; FIG. 9b—Si:Al=21; FIG. 9c—Si:Al=60; FIG. 9d—Si:Al=117.

FIG. 10 shows the GC-MS total ion chromatogram (TIC) of the liquid products from PE over the 50:50 CNT/ZSM-5 catalyst composition wherein the PE to catalyst ratio is 1:1.

FIG. 11 shows the GC-MS total ion chromatogram (TIC) of the liquid products from PE over the 50:50 Mo₂C/ZSM-5 catalyst composition wherein the PE to catalyst ratio is 1:1.

FIG. 12 shows the GC-MS total ion chromatogram (TIC) of the liquid products from PE over the 50:50 Cr₃C₂/ZSM-5 catalyst composition wherein the PE to catalyst ratio is 1:1.

FIGS. 13a-13e show the GC-MS total ion chromatogram (TIC) of the liquid products from PE over a CBs/ZSM-5 catalyst composition at various microwave input powers. FIG. 13a —50 W; FIG. 13b—100 W; FIG. 13c—150 W; FIG. 13d—300 W; FIG. 13e—500 W.

### DETAILED DESCRIPTION OF THE INVENTION

### Definitions

As used herein the term “aromatic compound” refers to a hydrocarbon compound comprising one or more aromatic ring system. The aromatic compound may contain a single aromatic ring system (i.e. single aromatic ring system compounds), for example, benzene and alkyl substituted benzenes etc. Alternatively, the aromatic compound may contain more than one aromatic ring system (i.e. multi aromatic ring system compounds), for example, naphthalene, anthracene etc. Examples of aromatic compounds which may be produced by the process described herein include benzene, toluene, ethylbenzene, p-xylene, o-xylene, m-xylene, 1-ethyl-3-methyl-benzene, 1-ethyl-2-methyl-benzene, 1,2,3-trimethyl-benzene, cumene, naphthalene, 2-methyl-naphthalene, anthracene, phenanthracene etc. Examples of single aromatic ring system compounds are benzene, toluene, ethylbenzene, p-xylene, o-xylene, m-xylene, 1-ethyl-3-methyl-benzene, 1-ethyl-2-methyl-benzene, 1,2,3-trimethyl-benzene, and cumene. Aromatic compounds may be interchangeably referred to as “aromatics”.

As used herein the term “BTX” refers to a mixture of aromatic hydrocarbons comprising substantially only benzene, toluene, and xylene isomers (i.e. p-xylene, o-xylene, m-xylene). Suitably, BTX essentially consists of a mixture of benzene, toluene, and xylene isomers (i.e. p-xylene, o-xylene, m-xylene). Suitably, the BTX consists of a mixture of benzene, toluene, and xylene isomers (i.e. p-xylene, o-xylene, m-xylene).

As used herein the term “solid catalyst composition” refers to a catalyst composition which is solid at standard ambient temperature and pressure (SATP), i.e. at a temperature of 298.15 K (25° C.) and at 100,000 Pa (1 bar, 14.5 psi, 0.9869 atm).

As used herein the term “liquid product” refers to the portion of reaction product in the liquid state at standard ambient temperature and pressure (SATP), i.e. at a temperature of 298.15 K (25° C.) and at 100,000 Pa (1 bar, 14.5 psi, 0.9869 atm).

As used herein the term “gaseous product” refers to the portion of reaction product in the gas state at standard ambient temperature and pressure (SATP), i.e. at a temperature of 298.15 K (25° C.) and at 100,000 Pa (1 bar, 14.5 psi, 0.9869 atm).

As used herein, the term “upcycling” refers to the conversion of a material, generally a waste or unwanted material, into alternative materials which may either be more easily disposed of or have renewed application. Suitably, upcycling converts a material into an alternative material having at least one new application. In the present invention, waste plastic may be upcycled into a range of aromatic compounds, including for example, BTX.

As used herein, the term “depolymerise” refers to the deconstruction of a polymeric chemical structure to yield other compounds such as hydrocarbons, monomers or a mixture thereof.

As used herein the term “plastic” refers to a polymeric material (generally a solid at SATP) comprising one or more thermoplastic or thermosetting polymers. Suitably, the plastic (essentially) consists of one or more thermoplastic or thermosetting polymers. Suitably the plastic (essentially) consists of one or more thermoplastic polymers. Suitably, the plastic is waste plastic which may be a mixture of various plastics. Plastics may be referred to by the name of the polymer of which they consist. Examples of common plastics are polyethylene, polypropylene and polystyrene.

As used herein the term “thermoplastic polymer” refers to a polymer which becomes pliable or mouldable above a certain temperature and solidifies upon cooling, but can be re-melted on heating. Typically thermoplastic polymers have a melting temperature from about 60° C. to about 300° C., from about 80° C. to about 250° C., or from about 100° C. to about 250° C. Suitably, the thermoplastic polymer is one which is commonly comprised in commercial plastic products. Suitable thermoplastic polymers generally include polyolefins, polyesters, polyamides, copolymers thereof, and combinations thereof. Examples of thermoplastic polymers include high density polyethylene (HDPE), low density polyethylene (LDPE), polypropylene (PP), polystyrene (PS), polyvinylchloride (PVC), polyamideimide, polymethylmethacrylate (PMMA), polytetrafluoroethylene, polyethylene terephthalate (PET), natural rubber (NR), and polycarbonate (PC), polyvinylidene chloride (PVDC), acrylonitrile butadiene styrene (ABS), polyurethanes (PU).

As used herein the term “thermosetting polymer” refers to a polymer which is irreversibly cured and cannot be reworked upon reheating. Examples of thermosetting polymers are polyurethane and polyoxybenzylmethylenglycolanhydride (Bakelite™).

As used herein, the term “admixture” refers the physical combination of two or more substances in which the identities of each substance is retained. An admixture may suitably be prepared by mechanical mixing (e.g. grinding, milling or blending) two substances together.

As used herein, the term “selectivity” refers to the amount of production of a particular product as a proportion of the total of a given product. For example, if 0.1 grams of aromatic compounds are produced in a reaction and 0.05 grams of toluene are found in these aromatics, the selectivity to toluene amongst the aromatic products is 50%.

### Process

In one aspect, the present invention provides a process for producing one or more aromatic compound comprising exposing a feed composition comprising at least one plastic to microwave radiation in the presence of a solid catalyst composition, wherein the solid catalyst composition comprises a solid acid catalyst and a carbon source.

In one embodiment, the process produces one or more aromatic compound selected from benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene, cumene, naphthalene, and 2-methyl-naphthalene.

In another embodiment, the process produces one or more aromatic compound selected from benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene and cumene.

In another embodiment, the process produces one or more aromatic compound selected from benzene, toluene, ethylbenzene, p-xylene, o-xylene, m-xylene, 1-ethyl-3-methyl-benzene, 1-ethyl-2-methyl-benzene, 1,2,3-trimethyl-benzene and 1,3,5-trimethyl-benzene.

In another embodiment, the process produces one or more aromatic compound selected from benzene, toluene, ethylbenzene, p-xylene, o-xylene, m-xylene, 1-ethyl-3-methyl-benzene, 1-ethyl-2-methyl-benzene, 1,2,3-trimethyl-benzene, 1,3,5-trimethyl-benzene, naphthalene and 2-methyl-naphthalene.

In another embodiment, the process produces one or more aromatic compound selected from benzene, toluene, ethylbenzene, p-xylene, o-xylene and m-xylene. In another embodiment, the process produces a mixture aromatic compounds comprising benzene, toluene, ethylbenzene, p-xylene, o-xylene and m-xylene.

In another embodiment, the process produces one or more aromatic compound selected from benzene, toluene, p-xylene, o-xylene and m-xylene. In another embodiment, the process produces a mixture of aromatic compounds comprising benzene, toluene, p-xylene, o-xylene and m-xylene.

In another embodiment, the process produces one or more aromatic compound comprising single aromatic ring system compounds. In another embodiment, the process produces a mixture of aromatic compounds comprising single aromatic system compounds.

Suitably the process provides aromatics compounds such as single aromatic ring system compounds. Accordingly, in one embodiment, there is provided a process for producing one or more single aromatic ring system compound comprising exposing a feed composition comprising at least one plastic to microwave radiation in the presence of a solid catalyst composition, wherein the solid catalyst composition comprises a solid acid catalyst and a carbon source.

In another embodiment, there is provided a process for producing a mixture of single aromatic ring system compounds comprising exposing a feed composition comprising at least one plastic to microwave radiation in the presence of a solid catalyst composition, wherein the solid catalyst composition comprises a solid acid catalyst and a carbon source.

Suitably, the single aromatic ring system compounds are selected from one or more of benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene and cumene.

Suitably, the single aromatic ring system compounds are selected from one or more of benzene, toluene, ethylbenzene, p-xylene, o-xylene, m-xylene, 1-ethyl-3-methyl-benzene, 1-ethyl-2-methyl-benzene, 1,2,3-trimethyl-benzene and 1,3,5-trimethyl-benzene.

Suitably, the single aromatic ring system compounds are selected from one or more of benzene, toluene, ethylbenzene, p-xylene, o-xylene and m-xylene. Suitably, the single aromatic ring system compounds are a mixture of benzene, toluene, ethylbenzene, p-xylene, o-xylene and m-xylene.

Suitably, the single aromatic ring system compounds are selected from one or more of benzene, toluene, p-xylene, o-xylene and m-xylene. Suitably, the single aromatic ring system compounds are a mixture of benzene, toluene, p-xylene, o-xylene and m-xylene.

Suitably, the single aromatic ring system compounds comprise benzene, toluene, p-xylene, o-xylene and m-xylene.

Suitably the process provides a mixture of aromatic compounds such as BTX. Accordingly, in one embodiment, there is provided a process for producing BTX comprising exposing a feed composition comprising at least one plastic to microwave radiation in the presence of a solid catalyst composition, wherein the solid catalyst composition comprises a solid acid catalyst and a carbon source.

Aromatic compound mixtures produced by the process can be separated and purified by conventional distillation, membrane separation, hybrid membrane distillation, selective adsorption, or facilitated transport systems as are known in the art. Removal of impurities can be optionally performed before or after the separation of the aromatics from other condensable components.

In one embodiment, the process produces a mass yield of about 50% or more of liquid product relative to the mass of plastic in the feed composition. Suitably, a mass yield of about 55% or more, more suitably a mass yield of about 60% or more; more suitably a mass yield of about 65% or more; more suitably a mass yield about 70% or more; more suitably a mass yield of about 75% or more; more suitably a mass yield of about 80% or more of liquid product relative to the mass of plastic in the feed composition.

In one embodiment, the process produces a mass yield of about 50% to about 99% of liquid product relative to the mass of plastic in the feed composition. Suitably, about 55% to about 99% of liquid product relative to the mass of plastic in the feed composition; more suitably a mass yield of about 60% to about 99%; more suitably a mass yield about 65% to about 99%, more suitably a mass yield of about 65% to about 99%; more suitably a mass yield of about 70% to about 99%; or more suitably a mass yield of about 75% to about 99% of liquid product relative to the mass of plastic in the feed composition.

In one embodiment, the process produces a mass yield of about 50% to about 90% of liquid product relative to the mass of plastic in the feed composition. Suitably, about 55% to about 90% of liquid product relative to the mass of plastic in the feed composition; more suitably a mass yield of about 60% to about 90%; more suitably a mass yield about 65% to about 90%, more suitably a mass yield of about 65% to about 90%; more suitably a mass yield of about 70% to about 90%; or more suitably a mass yield of about 75% to about 90% of liquid product relative to the mass of plastic in the feed composition.

In one embodiment, the process produces a mass yield of about 50% to about 85% of liquid product relative to the mass of plastic in the feed composition. Suitably, about 55% to about 85% of liquid product relative to the mass of plastic in the feed composition; more suitably a mass yield of about 60% to about 85%; more suitably a mass yield about 65% to about 85%, more suitably a mass yield of about 65% to about 85%; more suitably a mass yield of about 70% to about 85%; or more suitably a mass yield of about 75% to about 85% of liquid product relative to the mass of plastic in the feed composition.

In one embodiment, the process produces a mass yield of about 20% or more of aromatic compounds relative to the mass of plastic in the feed composition. Suitably, a mass yield of about 30% or more; more suitably a mass yield of about 40% or more; more suitably a mass yield of about 50% or more; more suitably a mass yield about 60% or more; more suitably a mass yield of about 70% or more; more suitably a mass yield of about 75% or more of aromatic compounds relative to the mass of plastic in the feed composition.

In one embodiment, the process produces a mass yield of about 20% to about 99% of aromatic compounds relative to the mass of plastic in the feed composition. Suitably, about 30% to about 99% of aromatic compounds relative to the mass of plastic in the feed composition; more suitably a mass yield of about 40% to about 99%; more suitably a mass yield about 50% to about 99%, more suitably a mass yield of about 60% to about 99%; more suitably a mass yield of about 70% to about 99%; more suitably a mass yield of about 75% to about 99% of aromatic compounds relative to the mass of plastic in the feed composition.

In one embodiment, the process produces a mass yield of about 20% to about 90% of aromatic compounds relative to the mass of plastic in the feed composition. Suitably, about 30% to about 90% of aromatic compounds relative to the mass of plastic in the feed composition; more suitably a mass yield of about 40% to about 90%; more suitably a mass yield about 50% to about 90%, more suitably a mass yield of about 60% to about 90%; more suitably a mass yield of about 70% to about 90%; more suitably a mass yield of about 75% to about 90% of aromatic compounds relative to the mass of plastic in the feed composition.

In one embodiment, the process produces a mass yield of about 20% to about 85% of aromatic compounds relative to the mass of plastic in the feed composition. Suitably, about 30% to about 85% of aromatic compounds relative to the mass of plastic in the feed composition; more suitably a mass yield of about 40% to about 85%; more suitably a mass yield about 50% to about 85%, more suitably a mass yield of about 55% to about 85%; more suitably a mass yield of about 60% to about 85%; more suitably a mass yield of about 65% to about 85%; more suitably a mass yield of about 70% to about 85% of aromatic compounds relative to the mass of plastic in the feed composition.

In one embodiment, the process produces a mass yield of about 20% to about 80% of aromatic compounds relative to the mass of plastic in the feed composition. Suitably, about 30% to about 80% of aromatic compounds relative to the mass of plastic in the feed composition; more suitably a mass yield of about 40% to about 80%; more suitably a mass yield about 50% to about 80%, more suitably a mass yield of about 55% to about 80%; more suitably a mass yield of about 60% to about 80%; more suitably a mass yield of about 65% to about 80%; more suitably a mass yield of about 70% to about 80% of aromatic compounds relative to the mass of plastic in the feed composition.

In one embodiment, the selectivity for aromatic compounds in the total liquid product is about 50% or more; suitably about 60% or more; suitably about 70% or more; suitably about 75% or more; suitably about 80% or more, suitably about 85% or more, suitably about 90% or more, suitably about 95% or more.

In one embodiment, the selectivity for aromatic compounds in the total liquid product is about 50% to about 99%. Suitably, about 60% to about 99%; suitably about 70% to about 99%; suitably about 75% to about 99%, suitably about 80% to about 99%; suitably about 85% to about 99%; suitably about 90% to about 99%.

In one embodiment, the selectivity for aromatic compounds in the total liquid product is about 50% to about 95%. Suitably, about 60% to about 95%; suitably about 70% to about 95%; suitably about 75% to about 95%, suitably about 80% to about 95%; suitably about 85% to about 95%.

In one embodiment, the selectivity for aromatic compounds in the total liquid product is about 50% to about 90%. Suitably, about 60% to about 90%; suitably about 70% to about 90%; suitably about 75% to about 90%, suitably about 80% to about 90%.

In one embodiment, the process produces a mass yield of about 20% or more of single aromatic ring system compounds relative to the mass of plastic in the feed composition. Suitably, a mass yield of about 30% or more, more suitably a mass yield of about 40% or more; more suitably a mass yield of about 50% or more; more suitably a mass yield about 60 or more; more suitably a mass yield of about 70% or more; more suitably a mass yield of about 75% or more of single aromatic ring system compounds relative to the mass of plastic in the feed composition.

In one embodiment, the process produces a mass yield of about 20% to about 99% of single aromatic ring system compounds relative to the mass of plastic in the feed composition. Suitably, about 30% to about 99% of single aromatic ring system compounds relative to the mass of plastic in the feed composition; more suitably a mass yield of about 40% to about 99%; more suitably a mass yield about 50% to about 99%, more suitably a mass yield of about 60% to about 99%; more suitably a mass yield of about 70% to about 99%; more suitably a mass yield of about 75% to about 99% of single aromatic ring system compounds relative to the mass of plastic in the feed composition.

In one embodiment, the process produces a mass yield of about 20% to about 90% of single aromatic ring system compounds relative to the mass of plastic in the feed composition. Suitably, about 30% to about 90% of single aromatic ring system compounds relative to the mass of plastic in the feed composition; more suitably a mass yield of about 40% to about 90%; more suitably a mass yield about 50% to about 90%, more suitably a mass yield of about 60% to about 90%; more suitably a mass yield of about 70% to about 90%; more suitably a mass yield of about 75% to about 90% of single aromatic ring system compounds relative to the mass of plastic in the feed composition.

In one embodiment, the process produces a mass yield of about 20% to about 80% of single aromatic ring system compounds relative to the mass of plastic in the feed composition. Suitably, about 30% to about 80% of single aromatic ring system compounds relative to the mass of plastic in the feed composition; more suitably a mass yield of about 40% to about 80%; more suitably a mass yield about 50% to about 80%, more suitably a mass yield of about 55% to about 80%; more suitably a mass yield of about 60% to about 80%; more suitably a mass yield of about 65% to about 80%; more suitably a mass yield of about 70% to about 80% of single aromatic ring system compounds relative to the mass of plastic in the feed composition.

In one embodiment, the process produces a mass yield of about 20% to about 70% of single aromatic ring system compounds relative to the mass of plastic in the feed composition. Suitably, about 30% to about 70% of single aromatic ring system compounds relative to the mass of plastic in the feed composition; more suitably a mass yield of about 40% to about 70%; more suitably a mass yield about 50% to about 70%, more suitably a mass yield of about 55% to about 70%; more suitably a mass yield of about 60% to about 70% of single aromatic ring system compounds relative to the mass of plastic in the feed composition.

In one embodiment, the process produces a mass yield of about 20% to about 65% of single aromatic ring system compounds relative to the mass of plastic in the feed composition. Suitably, about 30% to about 65% of single aromatic ring system compounds relative to the mass of plastic in the feed composition; more suitably a mass yield of about 40% to about 65%; more suitably a mass yield about 50% to about 65%, more suitably a mass yield of about 55% to about 65% of single aromatic ring system compounds relative to the mass of plastic in the feed composition.

In one embodiment, the process produces a mass yield of about 20% to about 60% of single aromatic ring system compounds relative to the mass of plastic in the feed composition. Suitably, about 30% to about 60% of single aromatic ring system compounds relative to the mass of plastic in the feed composition; more suitably a mass yield of about 40% to about 60%; more suitably a mass yield about 50% to about 60%, more suitably a mass yield of about 55% to about 60% of single aromatic ring system compounds relative to the mass of plastic in the feed composition.

In one embodiment, wherein the process produces single aromatic ring system compounds, the selectivity for single aromatic ring system compounds in the total aromatic compounds produced is about 50% or more. Suitably, about 55% or more, suitably about 60% or more; suitably about 65% or more; suitably about 70% or more; suitably about 75% or more; suitably about 80% or more; suitably about 85% or more, suitably about 90% or more.

In one embodiment, wherein the process produces single aromatic ring system compounds, the selectivity for single aromatic ring system compounds in the total aromatic compounds produced is about 20% to about 99%. Suitably, about 30% to about 99%; suitably about 40% to about 99%; suitably about 50% to about 99%, suitably about 60% to about 99%; suitably about 70% to about 99%; suitably about 75% to about 99%.

In one embodiment, wherein the process produces single aromatic ring system compounds, the selectivity for single aromatic ring system compounds in the total aromatic compounds produced is about 20% to about 95%. Suitably, about 30% to about 95%; suitably about 40% to about 95%; suitably about 50% to about 95%, suitably about 60% to about 95%; suitably about 65% to about 95%.

In one embodiment, wherein the process produces single aromatic ring system compounds, the selectivity for single aromatic ring system compounds in the total aromatic compounds produced is about 20% to about 90%. Suitably, about 30% to about 90%; suitably about 40% to about 90%; suitably about 50% to about 90%, suitably about 60% to about 90%; suitably about 70% to about 90%; suitably about 75% to about 90%.

In one embodiment, the process produces a mass yield of about 20% or more of BTX relative to the mass of plastic in the feed composition. Suitably, a mass yield of about 30% or more, more suitably a mass yield of about 40% or more; more suitably a mass yield of about 50% or more; more suitably a mass yield about 60% or more; more suitably a mass yield of about 70% or more; more suitably a mass yield of about 75% or more; more suitably a mass yield of about 80% or more; more suitably a mass yield of about 85% or more; more suitably a mass yield of about 90% or more of BTX relative to the mass of plastic in the feed composition.

In one embodiment, the process produces a mass yield of about 20% to about 99% of BTX relative to the mass of plastic in the feed composition. Suitably, about 30% to about 99% of BTX relative to the mass of plastic in the feed composition; more suitably a mass yield of about 40% to about 99%; more suitably a mass yield about 50% to about 99%, more suitably a mass yield of about 60% to about 99%; more suitably a mass yield of about 70% to about 99%; more suitably a mass yield of about 75% to about 99% of BTX relative to the mass of plastic in the feed composition.

In one embodiment, the process produces a mass yield of about 20% to about 90% of BTX relative to the mass of plastic in the feed composition. Suitably, about 30% to about 90% of BTX relative to the mass of plastic in the feed composition; more suitably a mass yield of about 40% to about 90%; more suitably a mass yield about 50% to about 90%, more suitably a mass yield of about 60% to about 90%; more suitably a mass yield of about 70% to about 90%; more suitably a mass yield of about 75% to about 90% of BTX relative to the mass of plastic in the feed composition.

In one embodiment, the process produces a mass yield of about 20% to about 80% of BTX relative to the mass of plastic in the feed composition. Suitably, about 30% to about 80% of BTX relative to the mass of plastic in the feed composition; more suitably a mass yield of about 40% to about 80%; more suitably a mass yield about 50% to about 80%, more suitably a mass yield of about 55% to about 80%; more suitably a mass yield of about 60% to about 80%; more suitably a mass yield of about 65% to about 80%; more suitably a mass yield of about 70% to about 80% of BTX relative to the mass of plastic in the feed composition.

In one embodiment, the process produces a mass yield of about 20% to about 70% of BTX relative to the mass of plastic in the feed composition. Suitably, about 30% to about 70% of BTX relative to the mass of plastic in the feed composition; more suitably a mass yield of about 40% to about 70%; more suitably a mass yield about 50% to about 70%, more suitably a mass yield of about 55% to about 70%; more suitably a mass yield of about 60% to about 70% of BTX relative to the mass of plastic in the feed composition.

In one embodiment, the process produces a mass yield of about 20% to about 65% of BTX relative to the mass of plastic in the feed composition. Suitably, about 30% to about 65% of BTX relative to the mass of plastic in the feed composition; more suitably a mass yield of about 40% to about 65%; more suitably a mass yield about 50% to about 65%, more suitably a mass yield of about 55% to about 65% of BTX relative to the mass of plastic in the feed composition.

In one embodiment, the process produces a mass yield of about 20% to about 60% of BTX relative to the mass of plastic in the feed composition. Suitably, about 30% to about 60% of BTX relative to the mass of plastic in the feed composition; more suitably a mass yield of about 40% to about 60%; more suitably a mass yield about 50% to about 60%, more suitably a mass yield of about 55% to about 60% of BTX relative to the mass of plastic in the feed composition.

In one embodiment, wherein the process produces BTX, the selectivity for BTX in the total aromatic compounds produced is about 20% or more. Suitably, about 30% or more, suitably about 40% or more; suitably about 50% or more; suitably about 60% or more; suitably about 70% or more; suitably about 75% or more; suitably about 80% or more, suitably about 85% or more, suitably about 90% or more, suitably about 95% or more.

In one embodiment, wherein the process produces BTX, the selectivity for BTX in the total aromatic compounds produced is about 20% to about 90%. Suitably, about 30% to about 90%; suitably about 40% to about 90%; suitably about 50% to about 90%, suitably about 60% to about 90%; suitably about 70% to about 90%; suitably about 75% to about 90%.

In one embodiment, wherein the process produces BTX, the selectivity for BTX in the total aromatic compounds produced is about 20% to about 80%. Suitably, about 30% to about 80%; suitably about 40% to about 80%; suitably about 50% to about 80%, suitably about 60% to about 80%; suitably about 70% to about 80%; suitably about 75% to about 80%.

In one embodiment, wherein the process produces BTX, the selectivity for BTX in the total aromatic compounds produced is about 20% to about 75%. Suitably, about 30% to about 75%; suitably about 40% to about 75%; suitably about 50% to about 75%, suitably about 60% to about 75%; suitably about 65% to about 75%.

In one embodiment, wherein the process produces BTX, the selectivity for BTX in the total aromatic compounds produced is about 20% to about 70%. Suitably, about 30% to about 70%; suitably about 40% to about 70%; suitably about 50% to about 70%, suitably about 55% to about 70%; suitably about 60% to about 70%.

In one embodiment, wherein the process produces BTX, the selectivity for BTX in the total liquid products produced is about 20% or more. Suitably, about 30% or more, suitably about 40% or more; suitably about 50% or more; suitably about 60% or more; suitably about 70% or more; suitably about 75% or more; suitably about 80% or more, suitably about 85% or more, suitably about 90% or more, suitably about 95% or more.

In one embodiment, wherein the process produces BTX, the selectivity for BTX in the total liquid products produced is about 20% to about 90%. Suitably, about 30% to about 90%; suitably about 40% to about 90%; suitably about 50% to about 90%, suitably about 60% to about 90%; suitably about 70% to about 90%; suitably about 75% to about 90%.

In one embodiment, wherein the process produces BTX, the selectivity for BTX in the total liquid products produced is about 20% to about 80%. Suitably, about 30% to about 80%; suitably about 40% to about 80%; suitably about 50% to about 80%, suitably about 60% to about 80%; suitably about 70% to about 80%; suitably about 75% to about 80%.

In one embodiment, wherein the process produces BTX, the selectivity for BTX in the total liquid products produced is about 20% to about 75%. Suitably, about 30% to about 75%; suitably about 40% to about 75%; suitably about 50% to about 75%, suitably about 60% to about 75%; suitably about 65% to about 75%.

In one embodiment, wherein the process produces BTX, the selectivity for BTX in the total liquid products produced is about 20% to about 70%. Suitably, about 30% to about 70%; suitably about 40% to about 70%; suitably about 50% to about 70%, suitably about 55% to about 70%; suitably about 60% to about 70%.

The process of the present invention is particularly suited to the processing of plastic, particularly waste plastic. Accordingly, the present invention also provides a process for upcycling plastic, particularly waste plastic, wherein the process comprises exposing a feed composition comprising at least one plastic to microwave radiation in the presence of a solid catalyst composition, wherein the solid catalyst composition comprises a solid acid catalyst and a carbon source.

In one embodiment, the process of each of the above embodiments is carried out in an atmosphere substantially free of oxygen. Suitably, an atmosphere free of oxygen. In another embodiment, process comprises exposing the feed composition to microwave radiation in an atmosphere substantially free of oxygen, suitably free of oxygen.

In another embodiment, the process is carried out in an atmosphere substantially free of water. Suitably, an atmosphere free of water. In another embodiment, process comprises exposing the feed composition to microwave radiation in an atmosphere substantially free of water, suitably free of water.

In another embodiment, the process is carried out in an atmosphere substantially free of oxygen and water. Suitably, an atmosphere free of oxygen and water. In another embodiment, process comprises exposing the feed composition to microwave radiation in an atmosphere substantially free of oxygen and water, suitably free of oxygen and water.

In another embodiment, the process is carried out in an inert atmosphere. In another embodiment, process comprises exposing the feed composition to microwave radiation in an inert atmosphere.

The inert atmosphere may for instance be an inert gas or a mixture of inert gases. The inert gas or mixture of inert gases typically comprises a noble gas, for instance argon. In one embodiment the inert gas is argon. In another embodiment the inert gas is nitrogen.

The process may comprise purging the feed composition with an inert gas or mixture of inert gases prior to exposing the feed composition to the microwave radiation.

The process may comprise purging the solid catalyst composition with an inert gas or mixture of inert gases prior to exposing the feed composition to the microwave radiation.

In one embodiment the feed composition is contacted with the catalyst composition prior to, during or both prior to and during exposure to the microwave radiation. The feed composition may be contacted with the catalyst by any suitable method. For instance, the feed composition may be mixed with the solid catalyst composition. The feed composition may be mixed with the solid catalyst composition by methods known in the art such as milling, grinding, extruding or blending. Suitably the feed composition and the catalyst composition are in admixture during exposure to the microwave radiation.

In one embodiment, the feed composition and the catalyst composition are in admixture prior to exposure to the microwave radiation. The feed composition and solid catalyst composition may be in admixture in the form of a powder or pellets. Accordingly, the feed composition and the solid catalyst composition may be combined (suitably as an admixture) to form a reaction composition in a separate step prior to being exposed to microwave radiation. Alternatively, the feed composition and the solid catalyst composition may be fed separately into a microwave reactor.

The ratio of feed composition to solid catalyst composition may vary and can be adjusted based on the process condition used. Aromatic compounds can be produced from plastics at high or low catalyst to feed ratios. However, in one embodiment, the ratio of feed composition to solid catalyst composition is about 50:1 to about 1:10, suitably about 50:1 to about 1:1. In another embodiment, the ratio of feed composition to solid catalyst composition is about 10:1 to about 1:10, suitably about 10:1 to about 1:1. In another embodiment, the ratio of feed composition to solid catalyst composition is about 5:1 to about 1:5, suitably about 5:1 to about 1:1. In another embodiment, the ratio of feed composition to solid catalyst composition is about 3:1 to about 1:3, suitably about 3:1 to about 1:1. In another embodiment, the ratio of feed composition to solid catalyst composition is about 5:1, or about 4:1, or about 3:1, or about 2:1, or about 1:1.

In the process of the invention, the feed composition is exposed to microwave radiation in the presence of the solid catalyst composition in order to effect, or activate, the partial depolymerisation of the polymers in the composition followed by aromatisation of the products thereof. Typically, said depolymerisation and aromatisation is catalytic. Exposing the feed composition to the microwave radiation may cause the feed composition to heat up, but does not necessarily cause it to be heated. Other possible effects of the microwave radiation to which the feed composition and/or catalyst composition is exposed (which may be electric or magnetic field effects) include, but are not limited to, field emission, plasma generation and work function modification. For instance, the high fields involved can modify catalyst work functions and can lead to the production of plasmas at the catalyst surface, further shifting the character of the chemical processes involved. Any one or more of such effects of the microwave radiation may be responsible for, or at least contribute to, effecting, or activating, the catalytic depolymerisation of the plastic in the feed composition and the aromatisation of the depolymerisation products.

The process, and in particular the step of exposing the composition to the microwave radiation, may be carried out at temperatures and/or pressures other than SATP. Indeed, both very low and very high temperatures can be employed, i.e. from far below ambient to far above ambient, as could very low and high pressures. Usually, however, the step of exposing the composition to the electromagnetic radiation is carried out at temperatures and pressures that are at or relatively close to SATP.

The process may for instance comprise exposing the composition to the microwave radiation, at a temperature of from −20° C. to 300° C., for instance from 0° C. to 200° C., or at a temperature of from 5° C. to 100° C., or for instance from 10° C. to 50° C.

Additionally, the process may comprise exposing the composition to the microwave radiation, at a pressure of from 0.01 bar to 100 bar, or for instance at a pressure of from 0.1 10 bar to 10 bar, for instance from 0.5 bar to 5 bar, or for example from 0.5 bar to 2 bar. In a more typical case, the process comprises exposing the composition to the electromagnetic radiation, at a temperature of from 0° C. to 200° C. and at a pressure of from 0.5 bar to 5 bar. For instance, it may comprise exposing the composition to the electromagnetic radiation, at a temperature of from 10° C. to 50° C. and at a pressure of from 0.5 bar to 2 bar.

Typically, the process is complete in about 1 second to about 3 hours, for instance in a batch-wise process. Suitably, the process is complete within about 1 second to about 1 hour, more suitably about 1 second to about 10 minutes, more suitably about 1 second to about 5 minutes.

In one embodiment, the process is complete in 10 seconds to about 3 hours, for instance in a batch-wise process. Suitably, the process is complete within about 10 seconds to about 1 hour, more suitably about 10 seconds to about 10 minutes, more suitably about 10 seconds to about 5 minutes.

In another embodiment, the process is complete in 30 seconds to about 3 hours, for instance in a batch-wise process. Suitably, the process is complete within about 30 seconds to about 1 hour, more suitably about 30 seconds to about 10 minutes, more suitably about 30 seconds to about 5 minutes.

Although the process may be performed batch-wise, a continuous mode may be employed. Thus, in one embodiment, the process comprises a preceding step of combining the feed composition and the solid catalyst composition to give a reaction composition.

Any suitable feeding rate may be employed for feeding the reaction composition to the microwave reactor. For instance, the mixture of plastics and solid catalyst composition (reaction composition) may be fed to microwave reactor at a feeding rate of equal to or greater than about 0.1 kg·h⁻¹. For instance, the reaction composition may be fed to microwave reactor at a feeding rate of equal to or greater than about 1 kg·h⁻¹. Suitably, the feeding rate is equal to or greater than about 10 kg·h⁻¹, for instance equal to or greater than about 100 kg·h⁻¹, or for example equal to or greater than about 1,000 kg·h⁻¹.

In one embodiment feeding rate of the reaction composition is from about 0.1 kg·h⁻¹ to about 2,000 kg·h⁻¹. For example, a feeding rate of from about 0.1 kg·h 1 to about 1,000 kg·h 1. For example, a feeding rate of from about 0.1 kg·h 1 to about 500 kg·h⁻¹. For example, a feeding rate of from about 0.1 kg·h⁻¹ to about 100 kg·h⁻¹. For example, a feeding rate of from about 0.1 kg·h⁻¹ to about 10 kg·h⁻¹. For example, a feeding rate of from about 0.1 kg·h⁻¹ to about 1 kg·h⁻¹.

In one embodiment, there is provided a process for producing one or more aromatic compounds comprising (i) combining a feed composition comprising at least one plastic and a solid catalyst composition to give a reaction composition, and (ii) exposing the reaction composition to microwave radiation; wherein the solid catalyst composition comprises a solid acid catalyst and a carbon source, suitably wherein the carbon source is a carbon black.

In one embodiment, there is provided a process for producing one or more aromatic compounds comprising (i) combining a feed composition comprising at least one plastic and solid catalyst composition to give a reaction composition, and (ii) exposing the reaction composition microwave radiation, wherein the solid catalyst composition comprises a zeolite and a carbon source, suitably wherein the zeolite is a ZSM-5 zeolite.

In one embodiment, there is provided a process for producing one or more aromatic compounds comprising exposing a feed composition comprising polyethylene or polypropylene to microwave radiation in the presence of a solid catalyst composition, wherein the solid catalyst composition comprises a zeolite and a carbon source, suitably wherein the zeolite is a ZSM-5 zeolite.

In another embodiment, there is provided a process for producing one or more aromatic compounds comprising exposing a feed composition comprising at least one plastic to microwave radiation in the presence of a solid catalyst composition, wherein the solid catalyst composition comprises a ZSM-5 zeolite and a carbon black.

In another embodiment, there is provided a process for producing one or more aromatic compounds comprising exposing a feed composition comprising at least about 70 wt. % of plastic to microwave radiation in the presence of a solid catalyst composition, wherein the solid catalyst composition comprises an acidic zeolite and carbon black; suitably wherein the feed composition and solid acid composition are heated to between 150° C. and 350° C.

In another embodiment, there is provided a process for producing BTX comprising exposing a feed composition comprising at least one plastic to microwave radiation in the presence of a solid catalyst composition, wherein the solid catalyst composition comprises a zeolite and a carbon black, suitably wherein the zeolite is an acidic zeolite, more suitably an acidic ZSM-5 zeolite.

### Solid Catalyst Composition

The process of the invention comprises contacting the feed composition with a solid catalyst composition, wherein the solid catalyst composition comprises a solid acid catalyst and a carbon source.

In one aspect, the present invention relates to a solid catalyst composition comprising a solid acid catalyst in admixture with a carbon source.

In one embodiment, the solid catalyst composition essentially consists of, or consists of a solid acid catalyst in admixture with a carbon source.

Solid acid catalysts are well known to the skilled person. Well known examples include zeolites and clays.

In one embodiment, the solid acid catalyst comprises, essentially consists of, or consists of a zeolite, suitably an acidic zeolite.

As the skilled person will appreciate, aluminosilicate zeolites comprise SiO₄ and AlO₄ tetrahedra, and each AlO₄ tetrahedron, with its trivalent aluminium, bears an extra negative charge, which is balanced by mono-, bi- or tri-valent cations. Such zeolites are often prepared in their sodium form. However, surface acidity can be generated (to produce an acidic zeolite) by replacing Na⁺ by H⁺. Protons can be introduced into the structure through ion-exchanged forms, hydrolysis of water, or hydration of cations or reduction of cations to a lower valency state. In the case of hydrogen zeolites, protons associated with the negatively charged framework aluminium are the source of Brönsted acid activity and a linear relationship between catalytic activity and the concentration of protonic sites associated with framework aluminium has been demonstrated.

In one embodiment, the solid acid catalyst comprises, essentially consists of, or consists of a zeolite, suitably selected from the group consisting of ZSM-5, ZSM-11, ZSM-23, ZSM-35, ZSM-57, Y-type zeolite, X-type zeolite, zeolite beta, MCM-22, SSZ-23, SUZ-4, (S)AlPO-31, SAPO-34, mordenite and faujasite.

In another embodiment, the solid acid catalyst comprises, essentially consists of, or consists of a zeolite, suitably selected from the group consisting of ZSM-5 and Y-type zeolite.

In one embodiment, the solid acid catalyst comprises, essentially consists of, or consists of a hydrogen zeolite (an H-zeolite). For instance, H-ZSM-5, H-Beta, H-Y or H-Mordenite.

In another embodiment, the solid acid catalyst comprises, essentially consists of, or consists of acidic silicon aluminium phosphate (SAPO) zeolites, for instance SAPO-34. SBA is also a suitable zeolite catalyst that may be employed.

In one embodiment, the solid acid catalyst comprises, essentially consists of, or consists of a zeolite selected from an acidic aluminosilicate zeolite, an acidic silicon aluminium phosphate (SAPO) zeolite or a metallosillicate analogue of zeolite, such as a ferrosilicate.

In another embodiment, the solid acid catalyst comprises, essentially consists of, or consists of a zeolite selected from an acidic aluminosilicate zeolite having the general formula (I):

$${[ {M}^{n +} ]}_{x / n} [ {( {AlO}_{{2}^{-}} )}_{x} {( {SiO}_{2} )}_{y} ] \qquad ( I )$$

wherein
M is H⁺ or M is two or more different cations, one of which is H⁺;
n is the valance of the cation; and
the Si:Al ratio y/x is from 1 to 300.

In one embodiment, the Si:Al ratio y/x may for instance be from about 20 to about 90, for instance be from about 20 to about 80, for instance from about 20 to about 60, or for example from about 30 to about 60, or from about 40 to about 60. In one embodiment, the Si:Al ratio y/x is about 50.

In one embodiment, when M is two or more different cations, one of which is H⁺, the charge ratio of H⁺ to the other cations M is typically equal to or greater than 1. In other words at least half of the positive charges arising from all the Mn⁺ cations are typically due to protons.

In one embodiment, the zeolite has a Si:Al ratio of from about 2 to 200, for instance from about 5 to about 100, for instance from about 10 to about 80, or for example from about 10 to about 60.

In one embodiment, the zeolite has a Si:Al ratio of from about 10 to 90, for instance from about 10 to about 80, for instance from about 10 to about 60, or for example from about 20 to about 60, or about 30 to about 60, or from about 40 to about 60.

Typically, the solid acid catalyst is H-ZSM-5 with an Si:Al ratio of from 20 to 90, for instance from about 20 to about 80, for instance from about 20 to about 60, or for example from about 30 to about 60, or from about 40 to about 60. In one embodiment, the solid acid catalyst is H-ZSM-5 with an Si/Al ratio of about 50 to about 60. Such H-ZSM-5 catalysts are commercially available from ZEOLYST international Company.

In one embodiment, the solid acid catalyst is a clay, suitably an acid activated clay. Suitable clay catalysts may be selected from the illite, smectite, vermiculite and kaolinite groups. In one embodiment, the clay is a smectite clay, for instance a bentonite (also known as a montmorillonite) clay. Suitably the bentonite clay is acid activated.

The reactive properties of naturally occurring clays can be altered or enhanced by acid treatment/activation. Such treatments are accompanied by change in key physical properties such as surface area, pore volume, and surface acidity. Acid treatment disrupts the laminar structure of the clay and exposes parts of the interlayer surface to atmospheric N2 and non-swelling adsorbates. Thus surface area increases after dissolution of soluble lattice ions gradually in the octahedral sites. Due to the partial dissolution of Al³⁺, Mg²⁺ and Fe³⁺ ions, the protons of the hydroxyl groups at the corners of the octahedron may become more labile as a result of structural deformation and increased acidity.

In another embodiment, the solid acid catalyst may be a solid heteropolyacid. Suitable solid heteropolyacids include, for example, CsₓHₓ-3 PW₁₂O₄₀, H₃PW₁₂O₄₀·6H₂O, H₃PW₁₂O₄₀/K-10 clay, Ag_{0.5}H_{2.5} PW₁₂O₄₀, Zr_{0.7}H_{0.2} PW₁₂O₄₀ and H₃PW₁₂O₄₀/ZrO₂.

In one embodiment, the solid acid catalyst comprises a mesopororus solid acid catalyst. The meaning of the term “mesoporous” in the context of catalysis is well known in the art. For instance, the IUPAC Goldbook defines mesoporous as meaning pores of intermediate size between microporous and macroporous, in particular with widths between 2 nm and 0.05 μm.

In one embodiment, the solid acid catalyst comprises/essentially consists of/consists of a crystalline, mesoporous solid acid catalyst.

In one embodiment, the solid acid catalyst comprises, or essentially consists of, or consists of a mesoporous solid acid catalyst. In another embodiment, the solid acid catalyst comprises, essentially consists of or consists of a non-ordered mesoporous solid acid catalyst. In another embodiment, the solid acid catalyst comprises, essentially consists of or consists of an ordered mesoporous solid acid catalyst.

In one embodiment, the mesoporous solid acid catalyst may be any of the solid acid catalysts referred to above in mesoporous form. In one embodiment, the catalyst composition comprises a mesoporous zeolite catalyst, suitably a mesoporous H-zeolite catalyst.

In one embodiment, the catalyst composition comprises a mesoporous solid acid catalyst selected from a mesoporous acidic aluminosilicate zeolite or a mesoporous acidic silicon aluminium phosphate (SAPO) zeolite. In another embodiment, the catalyst composition comprises a mesoporous catalyst which is mesoporous H-ZSM-5.

In another embodiment, the solid acid catalyst comprises/essentially consists of/consists of a crystalline nano- or microporous solid acid catalyst.

In one embodiment, the solid acid catalyst may comprise one or more rare earth metals. For instance, zeolites may be rare-earth-exchanged. The rare-earth content may be higher than 0% and may be as high as 10% by weight of the zeolite, with from 0.1 to 3% by weight of zeolite being typical.

Suitable rare earth metals include cerium, lanthanum and other rare earth materials are La, Ce, Pr, Nd, Sm, Eu or Gd. In one embodiment, the rare earth metal is selected from La and Ce. In one embodiment, the solid acid catalyst comprises, essentially consists of, consists of a zeolite comprising a rare earth metal, suitably selected from La or Ce.

The carbon source may be selected from the group consisting of a carbon black (such as acetylene black, channel black, furnace black, lamp black and thermal black), activated carbon, graphene, graphite, carbon nanofiber, carbon nanotube, carbon nanohorn, carbon nanoballoon, fullerene, carbides, charcoal, coal or combinations thereof.

In one embodiment, the carbon source is selected from the group consisting of a carbon black (such as acetylene black, channel black, furnace black, lamp black and thermal black), activated carbon, graphene, graphite, carbon nanotube, carbides, char coal, coal or combinations thereof.

In another embodiment, the carbon source is selected from the group consisting of a carbon black (such as acetylene black, channel black, furnace black, lamp black and thermal black), activated carbon, graphene, graphite, char coal, coal or combinations thereof.

In another embodiment, the carbon source is a carbon black. Carbon black consists of pure elemental carbon in the form of colloidal particles that are produced by the incomplete combustion or thermal decomposition of gaseous or liquid hydrocarbons under controlled conditions. The physical appearance of carbon black is that of a finely divided powder. Two carbon black manufacturing processes produce nearly all of the world's carbon blacks. These are furnace black and thermal black. Other carbon blacks include acetylene black, channel black and lamp black. In one embodiment the carbon source comprises, essentially consists of, consists of one or more carbon blacks. Suitably the carbon source comprises, essentially consists of, consists of furnace black and/or thermal black.

In one embodiment, the carbon source is a carbide, such as a metal carbide. Suitable metal carbides are selected chromium carbide (e.g, Cr₃C₂), molybdenum carbide (e.g, Mo₂C), tungsten carbide (e.g, WC), zirconium carbide (e.g, ZrC), and titanium carbide (e.g, TiC).

In one embodiment the solid acid catalyst is a zeolite, suitably a ZSM-5 zeolite, more suitably a H-ZSM-5 zeolite and the carbon source is selected from group consisting of a carbon black, activated carbon, graphene, graphite, char coal, coal or combinations thereof.

In one embodiment, the carbon source is a carbon black and the solid acid catalyst is a zeolite, suitably a ZSM-5 zeolite, suitably H-ZSM-5 zeolite.

In one embodiment, the carbon source is a carbon black and the solid acid catalyst is hydrogen zeolite (an H-zeolite), such as H-ZSM-5, H-Beta, H-Y or H-Mordenite.

In one embodiment, the solid catalyst composition is a mechanical mixture of solid acid catalyst and a carbon source. That is to say the catalyst composition is a heterogeneous mixture of solid acid catalyst and carbon source. As such the solid acid catalyst is not chemically modified by the carbon source, they are simply in physical mixture.

In one embodiment, the solid catalyst composition comprises a solid acid catalyst and a carbon source, wherein the carbon source is not supported on the solid acid catalyst, i.e. not chemically bonded to the exterior or interior surface of the solid acid catalyst, or does not block the pores of the solid acid catalyst.

In one embodiment, the solid catalyst composition comprises at least about 1 wt. % of the carbon source relative to the total weight of the solid catalyst composition. For example, the catalyst composition may comprise at least about 3 wt. % of the carbon source relative to the total weight of the catalyst composition. Suitably, at least about 5 wt. % of the carbon source relative to the total weight of the catalyst composition.

In another embodiment, the solid catalyst composition comprises at least about 10 wt. % of the carbon source relative to the total weight of the catalyst composition, alternatively at least about 20 wt. % of the carbon source, or at least about 30 wt. %, or at least about 40 wt. %, or at least about 50 wt. % of the solid catalyst composition.

In one embodiment, the solid catalyst composition comprises about 1 wt. % to about 50 wt. % of the carbon source relative to the total weight of the solid catalyst composition. For example, the solid catalyst composition may comprise about 1 wt. % to about 40 wt. % of the carbon source relative to the total weight of the catalyst composition. Suitably, about 1 wt. % to about 30 wt. % of the carbon source relative to the total weight of the catalyst composition, more suitably about 1 wt. % to about 20 wt. % of the carbon source, more suitably about 1 wt. % to about 10 wt. % of the carbon source relative to the total weight of the catalyst composition.

In another embodiment, the solid catalyst composition comprises about 5 wt. % to about 20 wt. % of the carbon source relative to the total weight of the catalyst composition. For example, the solid catalyst composition may comprise about 5 wt. % to about 15 wt. % of the carbon source relative to the total weight of the catalyst composition. Suitably, about 5 wt. % to about 10 wt. % of the carbon source relative to the total weight of the catalyst composition.

In one embodiment, the solid catalyst composition comprises at least about 50 wt. % of the solid acid catalyst relative to the total weight of the solid catalyst composition. For example, the catalyst composition may comprise at least about 60 wt. % of the solid acid catalyst relative to the total weight of the catalyst composition. Suitably, at least 70 wt. % of the solid acid catalyst relative to the total weight of the catalyst composition.

In another embodiment, the solid catalyst composition comprises at least about 80 wt. % of the solid acid catalyst relative to the total weight of the catalyst composition, alternatively at least about 90 wt. % of the solid acid catalyst, or at least about 95 wt. % relative to the total weight of the catalyst composition.

In one embodiment, the solid catalyst composition comprises about 50 wt. % to about 99 wt. % of the solid acid catalyst relative to the total weight of the solid catalyst composition. For example, the solid catalyst composition may comprise about 50 wt. % to about 95 wt. % of the solid acid catalyst relative to the total weight of the catalyst composition.

In another embodiment, the solid catalyst composition comprises about 80 wt. % to about 99 wt. % of the solid acid catalyst relative to the total weight of the catalyst composition. For example, the solid catalyst composition may comprise about 80 wt. % to about 95 wt. % of the solid acid catalyst relative to the total weight of the catalyst composition.

In another embodiment, the solid catalyst composition comprises about 90 wt. % to about 99 wt. % of the solid acid catalyst relative to the total weight of the catalyst composition. For example, the solid catalyst composition may comprise about 95 wt. % to about 99 wt. % of the solid acid catalyst relative to the total weight of the catalyst composition.

In one embodiment, the ratio of solid acid catalyst to the carbon source in the solid catalyst composition is about 50:1 to about 1:1, suitably about 20:1 to about 1:1, suitably about 10:1 to about 1:1. In another embodiment, the ratio of solid acid catalyst to the carbon source in the solid catalyst composition is about 50:1 to about 5:1, suitably about 20:1 to about 5:1, suitably about 10:1 to about 5:1. In another embodiment, the ratio of solid acid catalyst to the carbon source in the solid catalyst composition is about 95:5 to about 4:1. In another embodiment, the ratio of solid acid catalyst to the carbon source in the solid catalyst composition is about 95:5 to about 9:1.

In one embodiment, the solid catalyst composition comprises, essentially consists of, or consists of a zeolite in admixture with a carbon source; suitably in a ratio of about 95:5 to about 9:1.

In another embodiment, the solid catalyst composition comprises, essentially consists of, or consists of a ZSM-5 zeolite in admixture with a carbon black; suitably in a ratio of about 95:5 to about 9:1.

In another embodiment, the solid catalyst composition comprises, essentially consists of, or consists of a H-zeolite in admixture with a carbon black; suitably in a ratio of about 95:5 to about 9:1.

Typically, the solid catalyst composition is in particulate form, such as pellets or powdered form, suitably wherein particle size is about 10 mm or less. In one embodiment, the particle size is about 5 mm or less, suitably, 1 mm or less. In another embodiment, the particle size is between about 100 nm and 1 mm.

The term “particle size” as used herein means the diameter of the particle if the particle is spherical or, if the particle is non-spherical, the volume-based particle size. The volume-based particle size is the diameter of the sphere that has the same volume as the non-spherical particle in question. Particle size as described herein can be determined by various conventional methods of analysis, such as SEM, TEM, Laser light scattering, laser diffraction, sieve analysis and optical microscopy (usually combined with image analysis).

In another aspect, the present invention relates to the use of a solid catalyst composition as defined in any of the above embodiments for upcycling plastic and/or the production of one or more aromatic compounds.

In one embodiment, the one or more aromatic compounds are selected from benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene, cumene, naphthalene, and 2-methyl-naphthalene.

In another embodiment, the one or more aromatic compounds are selected from benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene and cumene.

In another embodiment, the one or more aromatic compounds are selected from benzene, toluene, ethylbenzene, p-xylene, o-xylene, m-xylene, 1-ethyl-3-methyl-benzene, 1-ethyl-2-methyl-benzene, 1,2,3-trimethyl-benzene and 1,3,5-trimethyl-benzene.

In another embodiment, the one or more aromatic compounds are selected from benzene, toluene, ethylbenzene, p-xylene, o-xylene, m-xylene, 1-ethyl-3-methyl-benzene, 1-ethyl-2-methyl-benzene, 1,2,3-trimethyl-benzene, 1,3,5-trimethyl-benzene, naphthalene and 2-methyl-naphthalene.

In another embodiment, the one or more aromatic compounds are selected from benzene, toluene, ethylbenzene, p-xylene, o-xylene and m-xylene.

In another embodiment, the one or more aromatic compounds are selected from benzene, toluene, p-xylene, o-xylene and m-xylene.

In another embodiment, there is provided use of a solid catalyst composition as defined in any of the above embodiments for producing aromatic compounds comprising one or more single aromatic ring system compound.

In another embodiment, there is provided use of a solid catalyst composition as defined in any of the above embodiments for producing a mixture of single aromatic ring system compounds.

Suitably, the single aromatic ring system compounds are selected from one or more of benzene, toluene, ethylbenzene, p-xylene, o-xylene, m-xylene, 1-ethyl-3-methyl-benzene, 1-ethyl-2-methyl-benzene, 1-methyl-4-propyl-benzene, 1,2,3-trimethyl-benzene, 1,3,5-trimethyl-benzene and cumene.

Suitably, the single aromatic ring system compounds are selected from one or more of benzene, toluene, ethylbenzene, p-xylene, o-xylene, m-xylene, 1-ethyl-3-methyl-benzene, 1-ethyl-2-methyl-benzene, 1,2,3-trimethyl-benzene and 1,3,5-trimethyl-benzene.

Suitably, the single aromatic ring system compounds are selected from one or more of benzene, toluene, ethylbenzene, p-xylene, o-xylene and m-xylene.

Suitably, the single aromatic ring system compounds are selected from one or more of benzene, toluene, p-xylene, o-xylene and m-xylene.

Suitably, the single aromatic ring system compounds comprise benzene, toluene, p-xylene, o-xylene and m-xylene.

In another embodiment, there is provided the use of a solid catalyst composition as defined in any of the above embodiments for producing a mixture of aromatics compounds such as BTX. Accordingly, in one embodiment, there is provided the use of a solid catalyst composition as defined in any of the above embodiments for producing BTX.

### Feed Composition

The feed composition is typically in the solid state at standard ambient temperature and pressure (SATP), i.e. at a temperature of 298.15 K (25° C.) and at 100,000 Pa (1 bar, 14.5 psi, 0.9869 atm).

The feed composition comprises at least one plastic. In one embodiment, the feed composition comprises one or more thermoplastic polymers. In another embodiment, the feed composition comprises, essentially consists of, or consists of at least one plastic. In another embodiment, the feed composition comprises, essentially consists of, or consists of one or more plastics. In another embodiment, the feed composition comprises, essentially consists of, or consists of one or more thermoplastic polymers.

In one embodiment, the feed composition comprises one or more plastics selected from polyethylene (PE), polypropylene (PP), polyacetylene, polybutylene, polyolefin, polyethylene terephthalate (PET), polybutylene terephthalate (PBT), copolyester, polyester, polycarbonate, polyurethane, polyamide, polystyrene (PS), polyacetal, epoxies, poly cyanurate, polyacrylic, polyurea, vinyl ester, polyacrylonitrile, polyvinyl alcohol, polyvinylchloride (PVC), polyvinyl acetate, nylon, copolymers such as ethylene-propylene, EPDM, acrylonitrile-butadiene-styrene (ABS), nitrile rubber, natural and synthetic rubber, tires, styrene-butadiene, styrene-acrylonitrile, styrene-isoprene, styrene-maleic anhydride, ethylene-vinylacetate, nylon Dec. 6, 1966, filled polymers, polymer composites and plastic alloys.

Suitably, the plastics are selected from one or more of polyethylene (PE), polypropylene (PP), polystyrene (PS), polybutylene terephthalate (PBT), polyethylene terephthalate (PET), polyvinyl chloride (PVC), polyamide (PA), polypolycarbonate (PC), polyurethane (PU) and acrylonitrile butadiene styrene (ABS).

Suitably, the plastics comprise one or more of polyethylene or polypropylene.

The plastic may be obtained from polymer or plastic manufacturing processes, but is preferably obtained as waste or discarded materials, post-consumer recycled polymer materials, or materials separated from waste streams such as municipal solid waste.

Suitably, the plastic is waste plastic. The waste plastic can be a single plastic or, suitably, a mixed waste plastic.

The feed stream may contain heteroatoms such as oxygen, sulfur and nitrogen. The feed stream may comprise synthetic or semi-synthetic polymers or mixtures thereof, including polyolefins, aromatic polymers, fibre enforced composite materials, multi-layered plastics, mixed plastics waste, polyamides, and/or recycling refuses. In some embodiments the feed composition may contain other waste streams commonly associated with waste plastic, such as biomass.

In one embodiment, impurities may have been removed from the feed composition such that the feed composition is substantially all plastic, such as at least about 90 wt. % plastic, suitably at least about 95 wt. % plastic, suitably at least about 99 wt. % plastic.

In one embodiment, the feed composition comprises at least about 50 wt. % of one or more plastics, suitably at least about 65 wt. %, suitably at least about 70 wt. %, suitably at least about 80 wt. %. In another embodiment, the feed composition comprises at least about 90 wt. % one or more plastics, suitably at least about 95 wt. %.

In another embodiment, the feed composition comprises at least one thermoplastic polymer selected from polyethylene (PE), polypropylene (PP) and polystyrene (PS).

In another embodiment, the feed composition comprises at least one thermoplastic polymer selected from polyethylene (PE) and polypropylene (PP).

In one embodiment, the feed composition comprises/essentially consists/consists of one or more of polyethylene, polypropylene and polystyrene. In one embodiment, the feed composition comprises at least 50 wt. % of one or more of polyethylene, polypropylene and polystyrene. Suitably, the feed composition comprises at least 60 wt. % of one or more of polyethylene, polypropylene and polystyrene; suitably at least about 70 wt. %, suitably at least about 80 wt. %, suitably the feed composition comprises at least 90 wt. % of one or more of polyethylene, polypropylene and polystyrene.

In one embodiment, the feed composition comprises/essentially consists/consists of polyethylene and/or polypropylene. In one embodiment, the feed composition comprises at least 50 wt. % of polyethylene and/or polypropylene. Suitably, the feed composition comprises at least 60 wt. % of polyethylene and/or polypropylene, suitably at least about 70 wt. %, suitably at least about 80 wt. %, suitably the feed composition comprises at least 90 wt. % of polyethylene and/or polypropylene.

In one embodiment, the feed composition is substantially free of oxygen. In another embodiment, the feed composition is free of oxygen. Accordingly, the process of the present invention may comprise a step of pre-treating the feed composition to remove or reduce the oxygen content.

In one embodiment, the feed composition is substantially free of water. In another embodiment, the feed composition is free of water. Accordingly, the process of the present invention may comprise a step of pre-treating the feed composition to remove or reduce the water content.

In one embodiment, the feed composition is substantially free of oxygenated species and water. In another embodiment, the solid composition is free of oxygenated species and water. Accordingly, the process of the present invention may comprise a step of pre-treating the feed composition to remove or reduce the water and oxygen content.

In one embodiment, the particle size of the feed composition may be reduced before exposure to the solid catalyst composition and/or microwave radiation. The particle size of the feed composition may be reduced in a size reduction system prior to passing the feed to the microwave reactor. Such size reduction system may involve grinding or shredding.

The feed composition may comprise plastics in which at least 85% by mass, or at least 90% by mass, or at least 95% by mass of the particles pass through a 0.25 inch (0.6 cm), or 0.5 inch (1.2 cm), or 1.0 inch (2.5 cm), or 1.5 inch (3.7 cm), or 2 inch (5.0 cm) screen or wherein the feed composition comprises plastics mixtures in which at least 85% by mass, or at least 90% by mass, or at least 95% by mass of the particles have aspect ratios (ratio of length to width) of 2:1, or 3:1, or 5:1, or 10:1, or 40:1, or 77:1, or from 1:1 to 100:1, or from 1.5:1 to 40:1, or from 2:1 to 10:1. Average diameter (size) can be measured by sieving through mesh (screen).

Large-particle feed material may be more easily transportable and less difficult to process than small-particle feed material. On the other hand, in some cases it may be advantageous to feed small particles to the microwave reactor. The use of a size reduction system allows for the transport of large-particle feed between the source and the process, while enabling the feed of small particles to the reactor.

### Microwave Radiation

The electromagnetic radiation that is employed in the process of the invention, is microwave frequency radiation (i.e. microwave radiation).

The term “microwave radiation”, as used herein, takes its normal meaning, typically referring to electromagnetic radiation having a wavelength of from one meter to one millimetre, and having a corresponding frequency of from 300 MHZ (100 cm) to 300 GHz (0.1 cm).

In principle, microwave radiation having any frequency in the microwave range, i.e. any frequency of from 300 MHz to 300 GHZ, may be employed in the present invention. Typically, however, microwave radiation having a frequency of from 900 MHz to 4 GHZ, or for instance from 900 MHz to 3 GHZ, is employed.

In one embodiment, the microwave radiation has a frequency of from about 1 GHz to about 4 GHZ. Suitably, the microwave radiation has a frequency of about 2 GHz to about 4 GHZ, suitably about 2 GHz to about 3 GHZ, suitably about 2.45 GHz.

In one embodiment, the microwave radiation has a frequency selected from about 915 MHz and about 2.45 GHz.

The power which the microwave radiation needs to delivered to the feed composition and/or solid catalyst composition, in order to effect the production of aromatic compounds will vary, according to, for instance, the particular composition of the feed composition, the particular solid catalyst composition employed and the size, permittivity, particle packing density, shape and morphology of the composition. The skilled person, however, is readily able to determine a level of incident power which is suitable for effecting the production of aromatic compounds from a particular feed composition.

The process of the invention may for example comprise exposing the composition to microwave radiation which delivers a power, per cubic centimetre of the composition, of at least 1 Watt. It may however comprise exposing the feed composition and/or solid catalyst composition to microwave radiation which delivers a power, per cubic centimetre of the composition, of at least 5 Watts.

Often, for instance, the process comprises exposing the composition to microwave radiation which delivers to the composition a power of at least 10 Watts, or for instance at least 20 Watts, per cubic centimetre of the composition. The process of the invention may for instance comprise exposing the composition to microwave radiation which delivers to the composition at least 25 Watts per cubic centimetre of the composition.

Often, for instance, the process comprises exposing the composition to microwave radiation which delivers a power of from about 0.1 Watt to about 5000 Watts per cubic centimetre of the composition. More typically, the process comprises exposing the composition to microwave radiation which delivers a power of from about 0.5 Watts to 30 about 1000 Watts per cubic centimetre of the composition, or for instance a power of from about 1 Watt to about 500 Watts per cubic centimetre of the composition, such as, for instance, a power of from about 1.5 Watts to about 200 Watts, or say, from 2 Watts to 100 Watts, per cubic centimetre of the composition.

In some embodiments, for instance the process comprises exposing the composition to microwave radiation which delivers to the composition from about 5 Watts to about 10 Watts per cubic centimetre of the composition, or for instance from about 10 Watts to about 100 Watts per cubic centimetre, or for instance from about 20 Watts, or from about 25 Watts, to about 80 Watts per cubic centimetre of the composition.

In some embodiments, for instance, the process comprises exposing the composition to microwave radiation which delivers a power of from about 2.5 to about 60 Watts per cubic centimetre of the composition. Thus, for example, if the volume of the composition is 3.5 cm3, the process of the invention typically comprises exposing the feed composition to microwave radiation which delivers about 10 W to about 200 W to the composition (i.e. the “absorbed power” is from about 10 W to about 200 W).

Often, the power delivered to the composition (or the “absorbed power”) is ramped up during the process of the invention. Thus, the process may comprise exposing the composition to microwave radiation which delivers a first power to the composition, and then exposing the composition to microwave radiation which delivers a second power to the composition, wherein the second power is greater than the first. The first power may for instance be from about 2.5 Watts to about 6 Watts per cubic centimetre of the composition. The second power may for instance be from about 25 Watts to about 60 Watts per cubic centimetre of the composition.

In one embodiment, the microwave input power is from about 500 W to about 10 KW, suitably from about 1 KW to about 10 KW, suitably about 2 KW to about 10 KW, suitably about 3 KW to about 10 KW, suitably about 4 KW to about 10 KW, suitably about 5 KW to about 10 KW.

In one embodiment, the microwave input power is from about 200 W to about 5 KW, suitably from about 200 W to about 4 KW, suitably about 200 W to about 3 KW, suitably about 200 W to about 4 KW, suitably about 200 W to about 5 KW.

In one embodiment, the microwave input power is from about 50 W to about 1500 W, suitably from about 50 W to about 1000 W, suitably about 50 W to about 500 W, suitably about 50 W to about 300 W, suitably about 50 W to about 200 W, suitably about 50 W to about 150 W.

In one embodiment, the microwave input power is from about 100 W to about 1500 W, suitably from about 100 W to about 1000 W, suitably about 100 W to about 500 W, suitably about 100 W to about 300 W, suitably about 100 W to about 200 W.

In one embodiment, the microwave input power is from about 150 W to about 1500 W, suitably from about 150 W to about 1000 W, suitably about 150 W to about 500 W, suitably about 150 W to about 300 W, suitably about 150 W to about 200 W, suitably about 150 W.

The duration of exposure of the composition to the microwave radiation may also vary in the process of the invention. Embodiments are, for instance, envisaged wherein a given feed composition and/or solid catalyst composition is exposed to microwave radiation over a relatively short period of time, to effect the production of aromatic compounds. For instance, the feed composition and/or solid catalyst composition may be irradiated with microwaves for a period of about 1 second to about 12 hours, suitably a period of about 1 second to about 6 hours, suitably about 1 second to about 3 hours.

In some embodiments, exposing the solid catalyst composition to the microwave radiation causes the solid catalyst composition or the feed composition to be heated. Microwave heating provides a method of fast, selective heating of dielectric and magnetic materials. Rapid and efficient heating using microwaves is an example in which inhomogeneous field distributions in dielectric mixtures and field-focusing effects can lead to dramatically different product distributions. The fundamentally different mechanisms involved in microwave heating versus traditional thermal processes may cause enhanced reactions and new reaction pathways. Furthermore, the high fields involved can modify catalyst work functions and can lead to the production of plasmas at the catalyst surface, further shifting the character of the chemical processes involved.

In one embodiment, the process of the invention comprises heating the solid catalyst composition and/or the feed composition by exposing the composition to the microwave radiation.

In one embodiment, the solid catalyst composition and/or the feed composition are heated to above about 25° C. upon exposure to microwave radiation, suitably above about 50° C., suitably above about 100° C., suitably above about 200° C. upon exposure to microwave radiation.

In one embodiment, the solid catalyst composition and/or the feed composition are heated to about 25° C. to about 500° C. upon exposure to microwave radiation, suitably about 50° C. to about 500° C., suitably about 100° C. to about 500° C., suitably about 150° C. to about 500° C., suitably about 200° C. to about 500° C., suitably about 250° C. to about 500° C., suitably about 300° C. to about 500° C. upon exposure to microwave radiation.

In one embodiment, the solid catalyst composition and/or the feed composition are heated to about 25° C. to about 400° C. upon exposure to microwave radiation, suitably about 50° C. to about 400° C., suitably about 100° C. to about 400° C., suitably about 150° C. to about 400° C., suitably about 200° C. to about 400° C., suitably about 250° C. to about 400° C., suitably about 300° C. to about 400° C. upon exposure to microwave radiation.

In one embodiment, the solid catalyst composition and/or the feed composition are heated to about 25° C. to about 350° C. upon exposure to microwave radiation, suitably about 50° C. to about 350° C., suitably about 100° C. to about 350° C., suitably about 150° C. to about 350° C., suitably about 200° C. to about 350° C., suitably about 250° C. to about 350° C., suitably about 300° C. to about 350° C. upon exposure to microwave radiation.

### Microwave Reactor

Exposure to microwave radiation will typically take place in a microwave reactor.

Typically, the reactor is configured to receive the composition to be exposed to radiation. The reactor typically therefore comprises at least one vessel (suitably one vessel) configured to comprise the feed composition and the solid catalyst composition. The composition may have been provided via an inlet to the vessel. The vessel may be located in a reaction cavity, said cavity being the focus of the microwave radiation.

The reactor may be also configured to export reaction products such as liquids or gases. Thus, the reactor typically comprises an outlet through which gas and/or liquid, generated in accordance with the process of the invention, may be released or collected.

In one embodiment, the microwave reactor is configured to subject the composition to electric fields in the TM010 mode.

In one embodiment, the microwave reactor has a power of between about 50 W to about 10 KW. In another embodiment, the microwave reactor has a power of between about 50 W to about 1500 W.

In one embodiment, the process of the invention takes place in a single reactor, suitably the aromatic compounds are recovered from said reactor.

The invention will now be further described by the following numbered paragraphs which are not the claims.
1. A process for producing one or more aromatic compounds comprising exposing a feed composition comprising at least one plastic to microwave radiation in the presence of a solid catalyst composition, wherein the solid catalyst composition comprises a solid acid catalyst and a carbon source.
2. A process according to paragraph 1 wherein the aromatic compounds comprise a mixture of single aromatic ring system compounds.
3. A process according to paragraph 1 wherein the aromatic compounds comprise a mixture of benzene, toluene and xylene isomers (BTX).
4. A process according to any one of the preceding paragraphs wherein the solid acid catalyst is a zeolite.
5. A process according to any one of paragraphs 1 to 3 wherein the solid acid catalyst is a clay.
6. A process according to paragraph 4 wherein the zeolite is selected from the group consisting of a ZSM-5, ZSM-11, ZSM-23, ZSM-35, ZSM-57, Y-type zeolite, X-type zeolite, zeolite beta, MCM-22, SSZ-23, SUZ-4, (S)AlPO-31, mordenite and faujasite.
7. A process according to paragraph 6 wherein the zeolite is a ZSM-5 zeolite.
8. A process according to paragraph 4 wherein the zeolite is selected from H-ZSM-5, H-Beta, H-Y or H-Mordenite.
9. A process according to paragraph 4 wherein the zeolite is selected from an acidic aluminosilicate zeolite, an acidic silicon aluminium phosphate (SAPO) zeolite or a metallosillicate analogue of zeolite.
10. A process according to any one of the preceding paragraphs wherein the Si:Al ratio of the zeolite is about 2 to about 200, suitably about 5 to about 100, suitably about 10 to about 80, suitably about 10 to about 60.
11. A process according to any one of the preceding paragraphs wherein the Si:Al ratio of the zeolite is about 20 to about 60.
12. A process according to any one of the preceding paragraphs wherein the average pore diameter of the zeolite is less than about 100 Angstroms, suitably less than about 50 Angstroms, suitably less than about 20 Angstroms, suitably less than about 10 Angstroms.
13. A process according to any one of the preceding paragraphs wherein the average pore diameter of the zeolite is from about 4 Angstroms to about 10 Angstroms, suitably about 5 Angstroms to about 8 Angstroms.
14. A process according to any one of the preceding paragraphs wherein the zeolite comprises a rare earth metal.
15 A process according to paragraph 14 wherein the rare earth metal is selected from La, Ce, Pr, Nd, Sm, Eu or Gd, suitably La or Ce.
16. A process according to paragraph 5 wherein the clay is a smectite clay, for instance a bentonite (also known as a montmorillonite) clay.
17. A process according to any one of the preceding paragraphs wherein the carbon source is selected from a carbon black, activated carbon, graphene, graphite, carbon nanofiber, carbon nanotube, carbon nanohorn, carbon nanoballoon, fullerene, carbides, charcoal, coal or combinations thereof.
18. A process according to paragraph 17 wherein the carbon source is a carbon black, suitably selected from one or more of acetylene black, channel black, furnace black, lamp black and thermal black.
19. A process according to any one of the preceding paragraphs wherein the carbon source is present from about 1 wt. % to about 50 wt. % of the total weight of the solid catalyst, suitably about 1 wt. % to about 30 wt. %.
20. A process according to any one of the preceding paragraphs wherein the carbon source is present from about 5 wt. % to about 20 wt. % of the total weight of the solid catalyst, suitably about 5 wt. % to about 10 wt. %.
21. A process according to any one of the preceding paragraphs wherein the solid catalyst consists of a ZSM-5 zeolite and a carbon black in a ratio of about 95:5 to about 90:10, suitably about 95:5.
22. A process according to any one of the preceding paragraphs wherein the feed composition comprises about 50% or more of one or more plastics, suitably about 80% or more of one or more plastics, suitably about 90% or more of one or more plastics.
23. A process according to any one of the preceding paragraphs wherein the feed composition comprises mixed waste plastic.
24. A process according to any one of the preceding paragraphs wherein the feed composition comprises at least one of polyethylene, polypropylene, polystyrene, polyethylene terephthalate (PET), polyvinyl chloride (PVC), polyamide, polypolycarbonate, polyurethane, and polyester.
25. A process according to any one of the preceding paragraphs wherein the feed composition comprises at least one of polyethylene and polypropylene.
26. A process according to any one of the preceding paragraphs wherein the feed composition and the solid catalyst composition are in admixture prior to and/or during exposure to microwave radiation.
27. A process according to any one of the preceding paragraphs wherein the ratio of feed composition to solid catalyst composition is about 50:1 to about 1:10, suitably about 20:1 to about 1:1.
28. A process according to any one of the preceding paragraphs wherein the ratio of feed composition to solid catalyst composition is about 3:1 to about 1:1.
29. A process according to any one of the preceding paragraphs wherein the process is carried out in an atmosphere substantially free of oxygen.
30. A process according to any one of the preceding paragraphs wherein the process is carried out in an atmosphere substantially free of water.
31. A process according to any one of the preceding paragraphs wherein the mass yield of liquid product produced by the process relative to the mass of plastic in the feed composition is about 60% or more, suitably about 70% or more, suitably about 75% or more.
32. A process according to any one of the preceding paragraphs wherein the mass yield of aromatic compounds relative to the mass of plastic in the feed composition is about 50% or more, suitably about 60%, suitably about 70% or more, suitably about 75% or more.
33. A process according to any one of the preceding paragraphs where in the mass yield of BTX relative to the mass of plastic in the feed composition is about 50% or more, suitably about 55%, suitably about 60% or more.
34. A process according to any one of the preceding paragraphs where the selectivity for BTX in the total aromatic compounds produced is about 50% or more, suitably about 60%, suitably about 70% or more, suitably about 75% or more.
35. A process according to any one of the preceding paragraphs wherein the feed composition and solid catalyst composition are heated to between about 150° C. to about 350° C. during exposure to microwave radiation.
36. A process according to any one of the preceding paragraphs wherein the process takes place in a microwave reactor.
37. A process according to paragraph 36 wherein the process further comprises the step of recovering the aromatic compounds from the reactor.
38. A process according to any one of the preceding paragraphs further comprising a preceding step of combining the feed composition and solid catalyst composition to provide a reaction composition prior to exposing said composition to microwave radiation.
39. A process according to any one of the preceding paragraphs further comprising a step of reducing the particle size of the feed composition prior to exposing said composition to the microwave radiation.
40. A solid catalyst composition comprising a solid acid catalyst in admixture with a carbon source.
41. A solid catalyst composition according to paragraph 40 wherein the solid acid catalyst is a zeolite.
42. A solid catalyst composition according to paragraph 40 wherein the solid acid catalyst is a clay
43. A solid catalyst composition according to paragraph 41 wherein the solid acid catalyst is a zeolite selected from the group consisting of a ZSM-5, ZSM-11, ZSM-23, ZSM-35, ZSM-57, Y-type zeolite, X-type zeolite, zeolite beta, MCM-22, SSZ-23, SUZ-4, (S)AlPO-31, mordenite and faujasite.
44. A solid catalyst composition according to paragraph 41 wherein the zeolite is a ZSM-5 zeolite.
45. A solid catalyst composition according to paragraph 41 wherein the zeolite is selected from H-ZSM-5, H-Beta, H-Y or H-Mordenite.
46. A solid catalyst composition according to paragraph 41 wherein the zeolite is selected from an acidic aluminosilicate zeolite, an acidic silicon aluminium phosphate (SAPO) zeolite or a metallosillicate analogue of zeolite.
47. A solid catalyst composition according to any one of paragraphs 41 to 46 wherein the Si:Al ratio of the zeolite is about 5 to about 200, suitably about 5 to about 100, suitably about 10 to about 80, suitably about 10 to about 60.
48. A solid catalyst composition according to any one of paragraphs 41 to 47 wherein the Si:Al ratio of the zeolite is about 20 to about 60.
49. A solid catalyst composition according to any one of paragraphs 41 to 48 wherein the average pore diameter of the zeolite is less than about 100 Angstroms, suitably less than about 50 Angstroms, suitably less than about 20 Angstroms, suitably less than about 10 Angstroms.
50. A solid catalyst composition according to any one of paragraphs 41 to 49 wherein the average pore diameter of the zeolite is from about 4 Angstroms to about 10 Angstroms, suitably about 5 Angstroms to about 8 Angstroms.
51. A solid catalyst composition according to any one of paragraphs 41 to 50 wherein the zeolite comprises a rare earth metal.
52. A solid catalyst composition according to paragraph 51 wherein the rare earth metal is selected from La, Ce, Pr, Nd, Sm, Eu or Gd, suitably La or Ce.
53. A solid catalyst composition according to any one of paragraphs 42 wherein the clay, is a smectite clay, for instance a bentonite (also known as a montmorillonite) clay.
54. A solid catalyst composition according to any one of paragraphs 40 to 53 wherein the carbon source is selected from a carbon black, activated carbon, graphene, graphite, carbon nanofiber, carbon nanotube, carbon nanohorn, carbon nanoballoon, fullerene, carbides, charcoal, coal or combinations thereof.
55. A solid catalyst composition according to paragraph 54 wherein the carbon source is a carbon black, suitably selected from one or more of acetylene black, channel black, furnace black, lamp black and thermal black.
56. A solid catalyst composition according to any one of paragraphs 40 to 55 wherein the carbon source is present from about 1 wt. % to about 50 wt. % of the total weight of the solid catalyst, suitably about 1 wt. % to about 30 wt. %.
57. A solid catalyst composition according to any one of paragraphs 40 to 56 wherein the carbon source is present from about 5 wt. % to about 20 wt. % of the total weight of the solid catalyst, suitably about 5 wt. % to about 10 wt. %.
58. A solid catalyst composition according to any one of paragraphs 40 to 57 wherein the solid catalyst consists of a ZSM-5 zeolite and a carbon black in a ratio of about 95:5 to about 90:10, suitably about 95:5.
59. A solid catalyst composition according to any one of paragraphs 40 to 58 in pelletized or powdered form.
60. Use of a solid catalyst composition according to any one of paragraphs 40 to 59 for upcycling plastic and/or the production of aromatic compounds.
61. The use according to paragraph 60 wherein the aromatic compounds comprise a mixture of single ring system aromatic compounds.
62. The use according to paragraph 60 wherein the aromatic compounds comprise a mixture of benzene, toluene and xylene isomers.

### EXAMPLES

### General Procedure for Solid Catalyst Composition Preparation:

The solid catalyst composition was prepared in facile manner by mechanically mixing a carbon source and a zeolite in a desirable weight ratio.

### General Reaction Method

The feed composition was mechanically mixed with the solid catalyst composition in the required ratio and then filled in a quartz tube and sealed with quartz wool. The sample was exposed to microwave irradiation for 10 minutes. The input power of microwave was 50 to 150 W (except where specified otherwise) and the bed temperature was between 180 and 350° C.

The generated gases were collected and analysed by gas chromatography (GC). Liquid products were collected by cold trap and/or extracted by washing the remaining materials included quartz wool and catalysts using dichloromethane. The extractants were than sampled and analysed in GCMS. The liquid products were then recovered by removing solvents.

### Example 1a—Polyethylene (PE) Upcycling Using Carbon Black/ZSM-5 Catalyst Composition with 1:1 Ratio of PE and Catalyst

The solid catalyst composition was prepared by mixing carbon blacks (CBs) (purchased from Alfa Aesar) and ZSM-5 powder (purchased from Zeolyst International) in a weight ratio of 5:95.

0.3 g of PE powder (purchased from Sigma-Aldrich) was physically mixed with 0.3 g of the 5:95 CBs/ZSM-5 catalyst composition. The sample was then exposed to microwave radiation for 10 minutes at an input power of 100 W.

About 25 mL of gaseous products were collected and 0.2379 g of liquid products recovered. The yield of aromatic compounds is about 79.3% relative to the mass of PE, and selectivity to single aromatic ring system compounds is about 91.5% amongst total liquid products. The BTX yield is about 54% relative to the mass of PE and selectivity to BTX is about 68% amongst total liquid products.

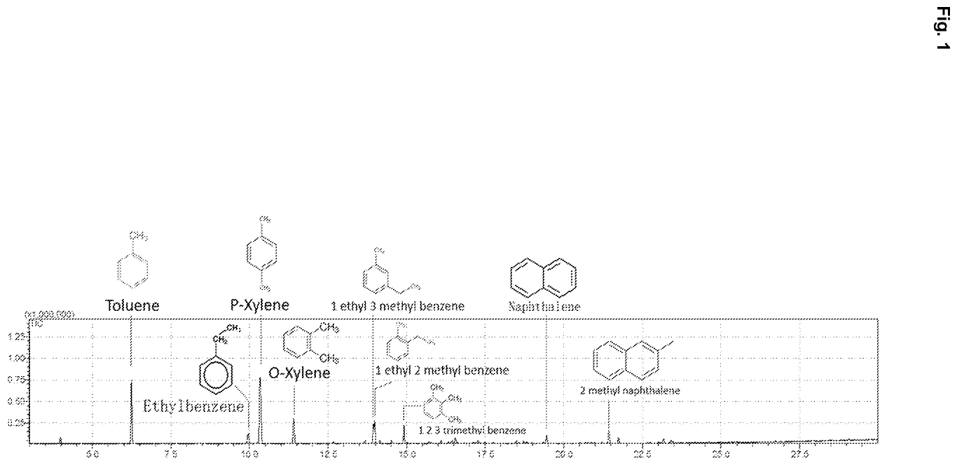

FIG. 1 shows the GC-MS total ion chromatogram (TIC) of the liquid products from PE over a 5:95 CBs/ZSM-5 catalyst composition and Table 1 shows the relative concentration of aromatics in the liquid products by GC-MS TIC.

TABLE 1

| Compounds | Concentration (%) |
|---|---|
| p-Xylene | 35.83 |
| Toluene | 21.78 |
| o-Xylene | 10.07 |
| Benzene, 1-ethyl-2-methyl- | 7.34 |
| Benzene, 1-ethyl-3-methyl- | 6.32 |
| Benzene, 1,2,3-trimethyl- | 5.72 |
| Ethylbenzene | 4.41 |
| Naphthalene, 2-methyl- | 4.04 |
| Naphthalene | 2.88 |
| Naphthalene, 2-methyl- | 1.61 |

### Example 1b—Polyethylene (PE) Upcycling Using Carbon Black/ZSM-5 Catalyst Composition with 2:1 Ratio of PE and Catalyst

0.4 g of PE powder (purchased from Sigma-Aldrich) was physically mixed with 0.2 g of the 5:95 CBs/ZSM-5 catalyst composition. The sample was then exposed to microwave radiation for 10 minutes at an input power of 100 W.

About 35 mL of gaseous products were collected and 0.3341 g of liquid products recovered. The yield of aromatic compounds is about 83.5% relative to the mass of PE and the selectivity to single aromatic ring system compounds is about 90%. The BTX yield is about 51% relative to the mass of PE and the selectivity for BTX amongst the total liquid products is about 62%.

FIG. 2 shows the GC-MS total ion chromatogram (TIC) of the liquid products from PE over the 5:95 CBs/ZSM-5 catalyst composition and Table 2 shows the relative concentration of aromatics in the liquid products by GC-MS TIC.

TABLE 2

| Compounds | Concentration (%) |
|---|---|
| p-Xylene | 34.44 |
| Toluene | 18.76 |
| Benzene, 1-ethyl-2-methyl- | 17.55 |
| Naphthalene | 6.35 |
| o-Xylene | 5.02 |
| Ethylbenzene | 4.34 |
| Benzene, 1-methyl-4-propyl- | 4.17 |
| Naphthalene, 2-methyl- | 3.45 |
| Benzene | 3.30 |
| Benzene, 1,3,5-trimethyl- | 2.61 |

### Example 1c—Polyethylene (PE) Upcycling Using Carbon Black/ZSM-5 Catalyst Composition with 3:1 Ratio of PE and Catalyst

0.3 g of PE powder (purchased from Sigma-Aldrich) was physically mixed with 0.1 g of the 5:95 CBs/ZSM-5 catalyst composition. The sample was then exposed to microwave radiation for 10 minutes at an input power of 100 W.

About 50 mL of gaseous products were collected and 0.2293 g of liquid products recovered. The yield of aromatic compounds is about 76.4% relative to the mass of PE and the selectivity to single aromatic ring system compounds is about 88%. The BTX yield is about 45% relative to the mass of PE and the selectivity for BTX amongst the total liquid products is about 59%.

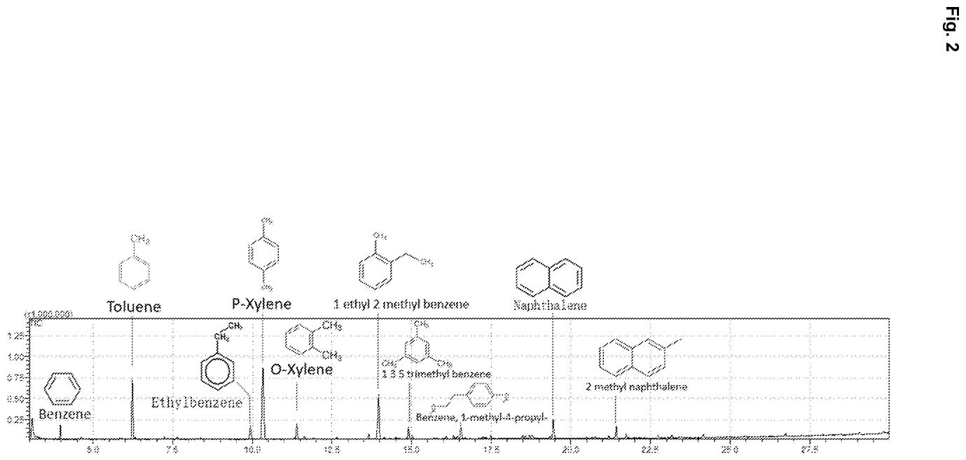

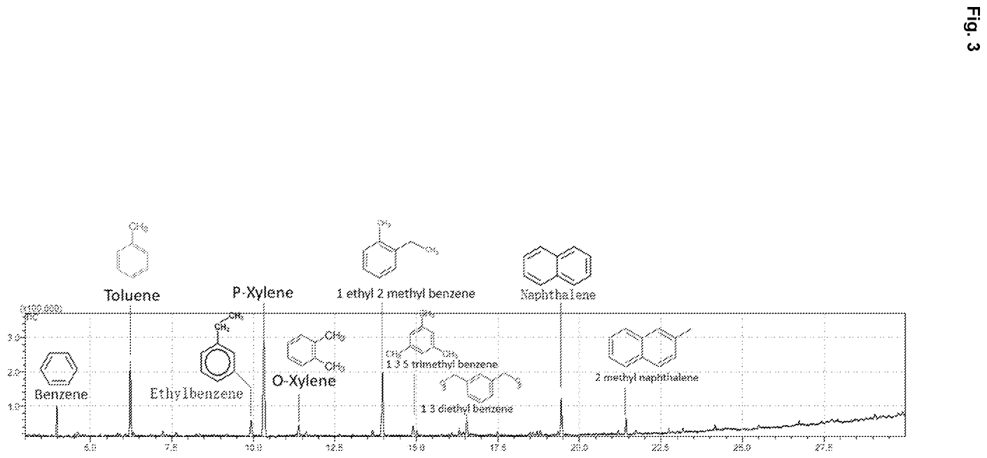

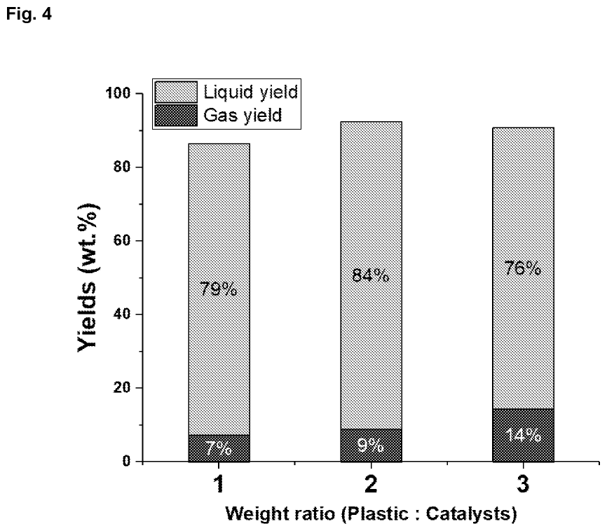

FIG. 3 shows the GC-MS total ion chromatogram (TIC) of the liquid products from PE over the 5:95 CBs/ZSM-5 catalyst composition and Table 3 shows the relative concentration of aromatics in the liquid products by GC-MS TIC.

TABLE 3

| Compounds | Concentration (%) |
|---|---|
| p-Xylene | 34.36 |
| Benzene, 1-ethyl-2-methyl- | 17.33 |
| Toluene | 17.11 |
| Naphthalene | 9.06 |
| Benzene | 5.48 |
| Ethylbenzene | 5.05 |
| Benzene, 1,3-diethyl- | 4.43 |
| Naphthalene, 2-methyl- | 3.27 |
| o-Xylene | 2.16 |
| Benzene, 1,3,5-trimethyl- | 1.75 |

In brief summary, despite the different mixing ratios of plastic and catalysts, the catalysts were functionally effective for the depolymerisation of plastic (here, represented by PE) and aromatisation of the products thereof. The liquid yields are similar for each ratio tested at about 80 wt. % but slightly more gases were produced at higher mixing ratio of plastics and catalysts. The mass balance is about 86-93% and the missing mass is attributed to the volatiles that are lost during the reaction and recovery process.

The liquid products are composed of nearly 100% aromatics with the selectivity to BTX is around 65%. The selectivity to single aromatic ring system compounds is about 90% or more.

### Example 2—Polypropylene (PP) Upcycling Using Carbon Black/ZSM-5 Catalyst Composition with 1:1 Ratio of PP and Catalyst

0.3 g of PP powder (purchased from Sigma-Aldrich) was physically mixed with 0.1 g of the 5:95 CBs/ZSM-5 catalyst composition. The sample was then exposed to microwave radiation for 10 minutes at an input power of 100 W.

About 20 mL of gaseous products were collected and 0.2412 g of liquid products recovered. The yield of aromatic compounds is about 80.4% relative to the mass of PP and the selectivity to single aromatic ring system compounds is about 88%. The BTX yield is about 57% relative to the mass of PP and the selectivity for BTX amongst the total liquid products is about 71%.

FIG. 5 shows the GC-MS total ion chromatogram (TIC) of the liquid products from PP over the 5:95 CBs/ZSM-5 catalyst composition and Table 4 shows the relative concentration of aromatics in the liquid products by GC-MS TIC.

TABLE 4

| Compounds | Concentration (%) |
|---|---|
| p-Xylene | 29.26 |
| Toluene | 26.43 |
| Naphthalene | 7.89 |
| o-Xylene | 7.64 |
| Benzene | 7.32 |
| Benzene, 1-ethyl-3-methyl- | 5.2 |
| Ethylbenzene | 4.23 |
| Benzene, 1-ethyl-2-methyl- | 4.23 |
| Naphthalene, 2-methyl- | 4.09 |
| Benzene, 1,3,5-trimethyl- | 3.71 |

### Example 3a—Polyethylene (PE) Upcycling Using Re-Cycled Carbon Black/ZSM-5 Catalyst Composition with 2:1 Ratio of PE and Catalyst

Cyclic experiments were carried out using a carbon black/ZSM-5 catalyst composition in a weight mixing ratio of 5:95. The mixing ratio of PE to catalyst composition was 2. The samples were exposed to 150 W microwaves for 10 minutes.

At the end of the reaction the spent catalyst composition is recovered and used in a further reaction cycle. 5 reaction cycles were conducted and the product profiles assessed.

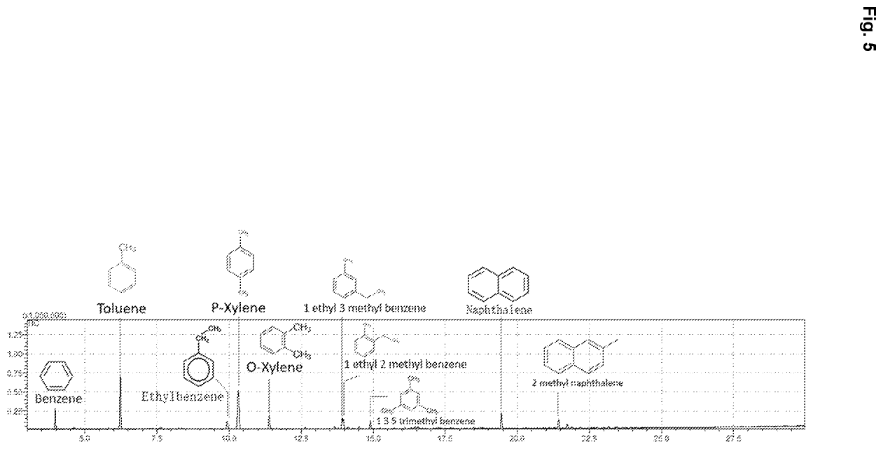

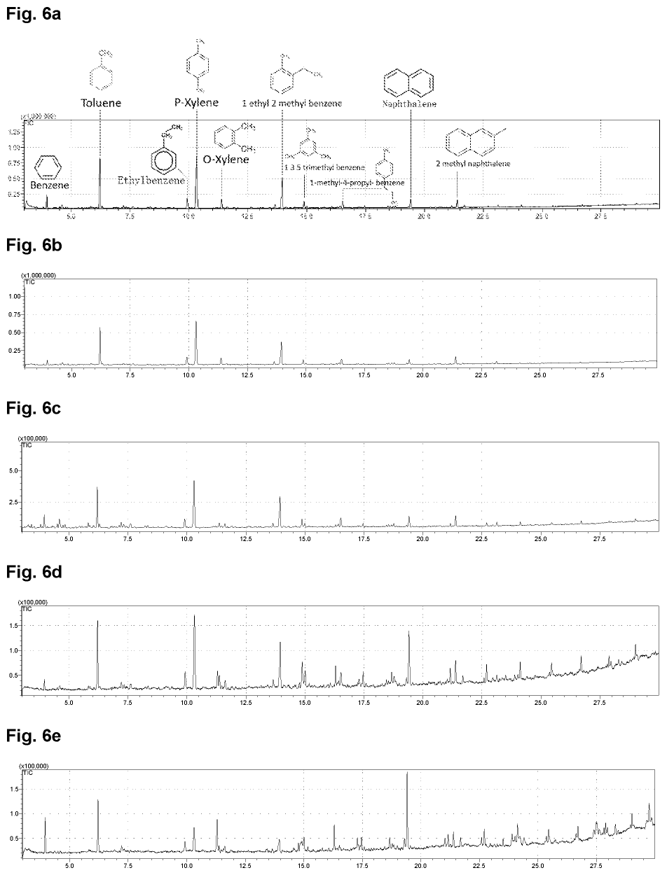

FIGS. 6a-6e show the GC-MS total ion chromatogram (TIC) of the liquid products for cycles 1 to 5 respectively. Table 5 shows the relative concentration of aromatics in the liquid products for each cycle by GC-MS TIC.

TABLE 5

| Cycle 1 | | Cycle 2 | | Cycle 3 | | Cycle 4 | | Cycle 5 | |
|---|---|---|---|---|---|---|---|---|---|
| | Conc. | | Conc | | Conc | | Conc | | Conc |
| Compounds | (%) | Compounds | (%) | Compounds | (%) | Compounds | (%) | Compounds | (%) |
| Benzene | 4.37 | Benzene | 1.82 | Benzene | 4.65 | Benzene | 1.45 | Benzene | 6.03 |
| Toluene | 21.69 | Cyclopropane, | 1.22 | Hexane, 3-methyl- | 1.17 | Toluene | 12.17 | Toluene | 11.75 |
| | | trimethylmethylene- | | | | | | | |
| Ethylbenzene | 5.34 | Toluene | 19.8 | 2-Hexene, 3-methyl-, | 4.78 | Ethylbenzene | 3.71 | Ethylbenzene | 2.30 |
| | | | | (Z)- | | | | | |
| Benzene, | 35.02 | 1,3-Dimethyl-1- | 0.98 | Cyclobutane, | 1.53 | Benzene, | 20.32 | Benzene, | 8.00 |
| 1,3-dimethyl- | | cyclohexene | | (1-methylethylidene)- | | 1,3-dimethyl- | | 1,3-dimethyl- | |
| o-Xylene | 4.39 | Ethylbenzene | 5.37 | Toluene | 16.38 | Styrene | 2.85 | Styrene | 8.69 |
| Benzene, | 16.1 | Benzene, | 35.7 | 1-Heptene, | 2.07 | o-Xylene | 2.31 | 5-Decene, (E)- | 6.84 |
| 1-ethyl-2-methyl- | | 1,3-dimethyl- | | 5-methyl- | | | | | |
| Benzene, | 2.6 | o-Xylene | 3.84 | Ethylbenzene | 4.32 | Benzene, | 11.32 | 4,4,6-Trimethyl-6- | 2.81 |
| 1,3,5-trimethyl- | | | | | | 1-ethyl-2-methyl- | | phenyltetrahydro- | |
| | | | | | | | | 1,3-oxazine-2-thione | |
| Benzene, | 3.69 | Benzene, propyl- | 1.39 | Benzene, | 29.33 | Benzene, | 5.85 | Indene | 4.94 |
| 1-methyl-4-propyl- | | | | 1,3-dimethyl- | | 1,3,5-trimethyl- | | | |
| Naphthalene | 3.9 | Benzene, | 15.09 | o-Xylene | 2.01 | Decane | 3.55 | 2-Methylindene | 2.03 |
| | | 1-ethyl-2-methyl- | | | | | | | |
| Naphthalene, | 2.9 | Benzene, | 2.29 | Benzene, | 15.57 | Indene | 3.37 | Naphthalene | 18.58 |
| 2-methyl- | | 1,2,3-trimethyl- | | 1-ethyl-2-methyl- | | | | | |
| | | Benzene, | 3.58 | Benzene, | 2.47 | Benzene, | 3.01 | Naphthalene, | 3.46 |
| | | 1-methyl-4-propyl- | | 1,3,5-trimethyl- | | 1-methyl-3-propyl- | | 2-methyl- | |
| | | Benzene, | 0.85 | Benzene, | 4.81 | Undecane | 1.85 | Tetradecane | 3.59 |
| | | 1-methyl-4- | | 1-methyl-3-propyl- | | | | | |
| | | (2-methylpropyl)- | | | | | | | |
| | | Naphthalene | 2.84 | Naphthalene | 5.3 | 2-Methylindene | 1.89 | Hexadecane | 3.21 |
| | | Naphthalene, | 3.87 | Naphthalene, | 3.97 | Naphthalene | 11.87 | Heptadecane | 2.70 |
| | | 2-methyl- | | 1-methyl- | | | | | |
| | | Naphthalene, | 1.36 | Naphthalene, | 1.64 | Tridecane | 2.03 | 1-Nonadecene | 5.47 |
| | | 2,6-dimethyl- | | 2,3-dimethyl- | | | | | |
| | | | | | | Naphthalene, | 3.41 | Heptadecane | 2.22 |
| | | | | | | 2-methyl- | | | |
| | | | | | | Tetradecane | 2.72 | Phenanthrene | 2.60 |
| | | | | | | Hexadecane | 2.25 | Heneicosane | 2.42 |
| | | | | | | Heptadecane | 2.36 | Tetratetracontane | 2.35 |
| | | | | | | Heneicosane | 1.71 | | |

### Example 3b—Polypropylene (PP) Upcycling Using Re-Cycled Carbon Black/ZSM-5 Catalyst Composition with 2:1 Ratio of PP and Catalyst

Cyclic experiments were carried out using a carbon black/ZSM-5 catalyst composition in a weight mixing ratio of 5:95. The mixing ratio of PP to catalyst composition was 2. The samples were exposed to 150 W microwaves for 10 minutes.

At the end of the reaction the spent catalyst composition is recovered and used in a further reaction cycle. 5 reaction cycles were conducted and the product profiles assessed.

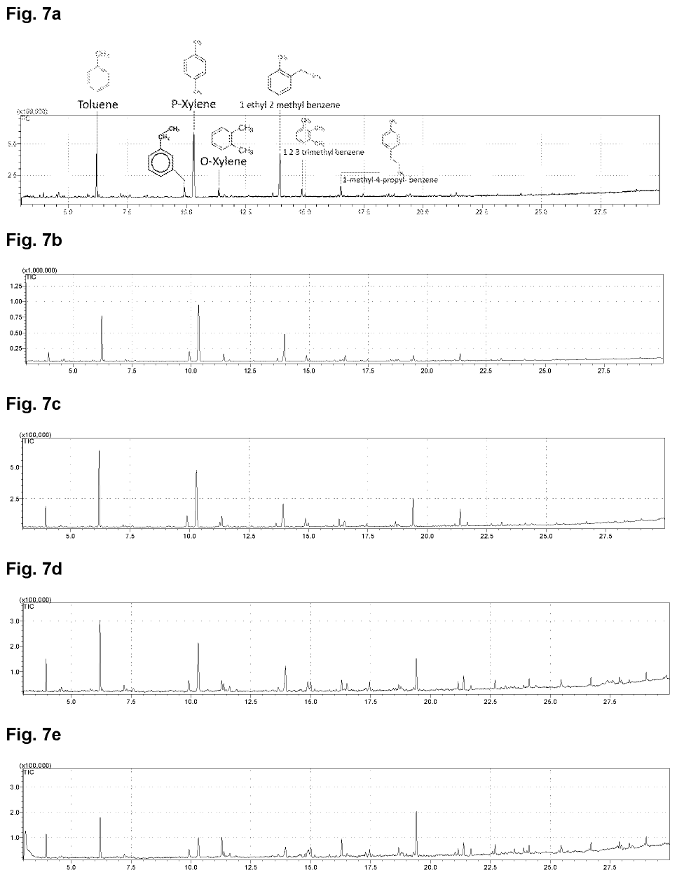

FIGS. 7a-7e show the GC-MS total ion chromatogram (TIC) of the liquid products for cycles 1 to 5 respectively. Table 6 shows the relative concentration of aromatics in the liquid products for each cycle by GC-MS TIC.

TABLE 6

| Cycle 1 | | Cycle 2 | | Cycle 3 | | Cycle 4 | | Cycle 5 | |
|---|---|---|---|---|---|---|---|---|---|
| | Conc | | Conc | | Conc | | Conc | | Conc |
| Compounds | (%) | Compounds | (%) | Compounds | (%) | Compounds | (%) | Compounds | (%) |
| Benzene | 1.38 | Cyclopentene, | 0.26 | Benzene | 4.76 | Benzene | 6.36 | Benzene | 6.29 |
| | | 1-methyl- | | | | | | | |
| Cyclopropane, | 2.25 | Benzene | 2.91 | Toluene | 23.96 | Toluene | 18.14 | Toluene | 13.89 |
| trimethylmethylene- | | | | | | | | | |
| Toluene | 18.15 | 1,4-Pentadiene, | 1.25 | Ethylbenzene | 4.45 | 1-Decene, | 1.6 | Ethylbenzene | 3.40 |
| | | 3,3-dimethyl- | | | | 2,4-dimethyl- | | | |
| Ethylbenzene | 5.04 | Toluene | 19.81 | p-Xylene | 27.44 | Ethylbenzene | 3.57 | Benzene, | 9.93 |
| | | | | | | | | 1,3-dimethyl- | |
| Benzene, | 39.39 | Hexane, | 0.83 | Styrene | 1.28 | p-Xylene | 19.56 | Styrene | 7.74 |
| 1,3-dimethyl- | | 2,4-dimethyl- | | | | | | | |
| o-Xylene | 4.24 | Ethylbenzene | 5.53 | o-Xylene | 3.63 | Styrene | 3.36 | Benzene, | 3.02 |
| | | | | | | | | 1-ethyl-4-methyl- | |
| Benzene, | 1.3 | Benzene, | 38.17 | Benzene, | 9.32 | o-Xylene | 2.29 | Benzene, | 6.08 |
| propyl- | | 1,3-dimethyl- | | 1-ethyl-2-methyl- | | | | 1-ethenyl-2-methyl- | |
| Benzene, | 20.13 | o-Xylene | 3.91 | Benzene, | 2.9 | Undecane, | 1.56 | Benzene, | 4.39 |
| 1-ethyl-2-methyl- | | | | 1,2,3-trimethyl- | | 3,7-dimethyl- | | 1-ethenyl-2-methyl- | |
| Benzene, | 2.63 | Benzene, propyl- | 1.07 | Benzene, | 1.34 | Benzene, | 8.06 | Indene | 5.40 |
| 1,2,3-trimethyl- | | | | 1-ethenyl-2-methyl- | | 1-ethyl-2-methyl- | | | |
| Benzene, | 5.49 | Benzene, | 14.62 | Indene | 2.25 | Benzene, | 4.12 | 2-Methylindene | 2.46 |
| 1-methyl-4-propyl- | | 1-ethyl-2-methyl- | | | | 1,3,5-trimethyl- | | | |
| | | Benzene, | 2.21 | 2-Tolyloxirane | 2.25 | Decane | 2.9 | Naphthalene | 16.66 |
| | | 1,3,5-trimethyl- | | | | | | | |
| | | Benzene, | 3.21 | 2-Methylindene | 1.3 | Indene | 2.8 | Naphthalene, | 4.29 |
| | | 1-methyl-4-propyl- | | | | | | 2-methyl- | |
| | | Naphthalene | 2.54 | Naphthalene | 8.97 | Benzene, | 2.62 | Naphthalene, | 1.91 |
| | | | | | | 1-methyl-2-propyl- | | 2-methyl- | |
| | | Naphthalene, | 2.82 | Naphthalene, | 5 | Naphthalene | 9.98 | 2,3- | 3.33 |
| | | 2-methyl- | | 2-methyl- | | | | Dimethyldodecane | |
| | | Naphthalene, | 0.86 | Naphthalene, | 1.15 | Naphthalene, | 3.57 | Hexadecane | 2.44 |
| | | 2,6-dimethyl- | | 2,6-dimethyl- | | 2-methyl- | | | |
| | | | | | | Tetradecane | 2.1 | Heptadecane | 2.36 |
| | | | | | | Pentadecane | 1.82 | Heptadecane | 2.10 |
| | | | | | | Hexadecane | 1.95 | Heneicosane | 1.97 |
| | | | | | | Heptadecane | 1.93 | Nonadecane | 2.35 |
| | | | | | | Nonadecane | 1.71 | | |

In brief summary, the liquid yields are between 70.2% to 82.3% relative to mass of plastic for the cyclic experiments. Although, the aromatics are dominant throughout the cyclic tests, more alkylated naphthalene is produced at late cycles. Also, more gases are produced at cycle 4 and cycle 5 corresponding to a slightly increase of gas yield. However, it is noted that the catalysts are functionally effective throughout the 5 cycles of experiments. Similar results are also observed on using either PE or PP as the feed composition.

### Example 4—Polyethylene (PE) Upcycling Using a Various Carbon Black/ZSM-5 Catalyst Compositions with 2:1 Ratio of PE and Catalyst

0.3 g of PE powder (purchased from Sigma-Aldrich) was physically mixed with 0.15 g of the CBs/ZSM-5 catalyst composition using CB:ZSM-5 ratios of 0:100, 2:98, 5:95, 10:90, 20:80 and 100:0. The sample was then exposed to microwave radiation for 10 minutes at an input power of 150 W, with the exception of 100% ZSM-5 which required a power of 1500 W for the reaction to proceed.

The liquid yields of samples with CB:ZSM-5 ratios of 2:98, 5:95, 10:90, 20:80 are between 73% to 80% relative to mass of PE and the selectivity to BTX is between 68% to 75% amongst the total liquid products. The liquid yield on pure ZSM-5 was 61% and 69% for pure carbon blacks relative to mass of PE. The liquid products obtained on pure carbon blacks are primarily linear hydrocarbons.

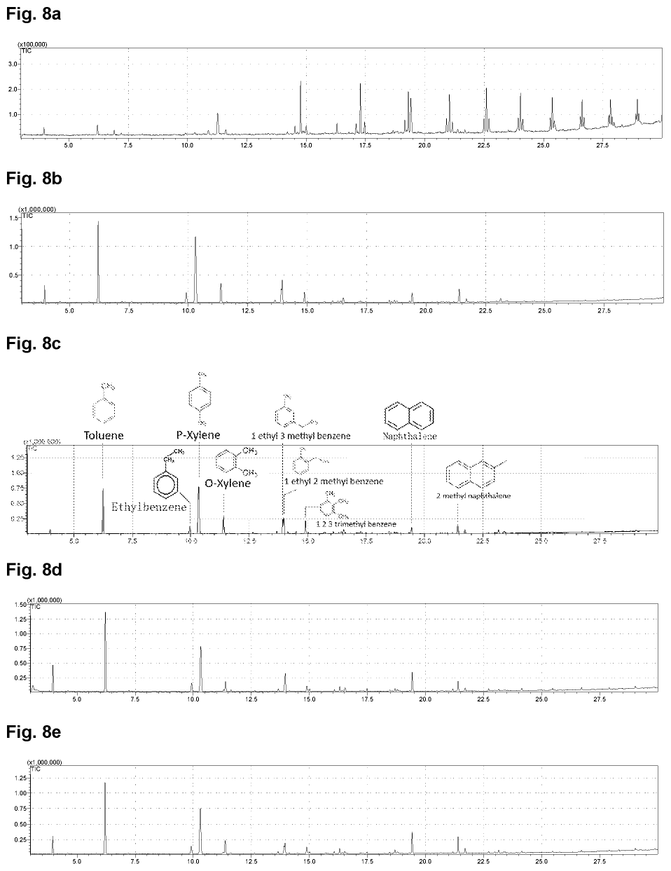

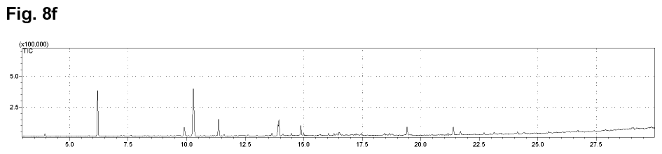

FIGS. 8a-8f show the GC-MS total ion chromatogram (TIC) of the liquid products for each of the different catalyst composition used. Table 7 shows the relative concentration of aromatics in the liquid products for each catalyst composition by GC-MS TIC.

TABLE 7

| 100% CBs | | CBs:ZSM-5 = 2:98 | | CBs:ZSM-5 = 5:95 | | CBs:ZSM-5 = 10:90 | | CBs:ZSM-5 = 20:80 | | 100% ZSM-5 | |
|---|---|---|---|---|---|---|---|---|---|---|---|
| | Conc. | | Conc. | | Conc. | | Conc. | | Conc. | | Conc. |
| Compounds | (%) | Compounds | (%) | Compounds | (%) | Compounds | (%) | Compounds | (%) | Compounds | (%) |
| 1-Nonene | 7.38 | Benzene | 4.29 | Toluene | 21.78 | Benzene | 8.04 | Benzene | 5.51 | Benzene | 3.21 |
| 1-Decene | 10.86 | Toluene | 27.31 | Ethylbenzene | 4.41 | Toluene | 31.90 | Toluene | 29.77 | Toluene | 23.08 |
| 1-Undecene | 9.71 | Ethylbenzene | 3.99 | p-Xylene | 35.83 | Ethylbenzene | 4.36 | Ethylbenzene | 3.96 | Ethylbenzene | 4.84 |
| 1-Dodecene | 7.67 | Benzene, | 35.78 | o-Xylene | 10.07 | Benzene, | 28.32 | p-Xylene | 29.43 | Benzene, | 35.26 |
| | | 1,3-dimethyl- | | | | 1,3-dimethyl- | | | | 1,3-dimethyl- | |
| Naphthalene | 10.63 | o-Xylene | 7.34 | Benzene, 1- | 6.32 | o-Xylene | 4.42 | o-Xylene | 6.2 | o-Xylene | 4.7 |
| | | | | ethyl-3-methyl- | | | | | | | |
| 1,11- | 2.46 | Benzene, 1- | 4.37 | Benzene, 1- | 7.34 | Benzene, 1- | 9.17 | Benzene, 1- | 2.89 | Benzene, 1- | 15.85 |
| Dodecadiene | | ethyl-3-methyl- | | ethyl-2-methyl- | | ethyl-2-methyl- | | ethyl-3-methyl- | | ethyl-2-methyl- | |
| 1-Tridecene | 7.85 | Benzene, 1- | 6.87 | Benzene, 1,2,3- | 5.72 | Benzene, 1,2,3- | 2.13 | Benzene, 1- | 3.93 | Benzene, 1,3,5- | 2.52 |
| | | ethyl-2-methyl- | | trimethyl- | | trimethyl- | | ethyl-2-methyl- | | trimethyl- | |
| 1,13- | 2.38 | Benzene, 1,3,5- | 3.08 | Naphthalene | 2.88 | Naphthalene | 8.01 | Benzene, 1,2,3- | 2.87 | Benzene, 1- | 3.78 |
| Tetradecadiene | | trimethyl- | | | | | | trimethyl- | | methyl-4-propyl- | |
| 1-Pentadecene | 8.99 | Naphthalene | 3.03 | Naphthalene, | 4.04 | Naphthalene, | 3.66 | Naphthalene | 9.03 | Naphthalene | 4.35 |
| | | | | 2-methyl- | | 2-methyl- | | | | | |
| Tetradecane | 3.28 | Naphthalene, | 3.94 | Naphthalene, | 1.61 | | | Naphthalene, | 6.41 | Naphthalene, | 2.41 |
| | | 2-methyl- | | 2-methyl- | | | | 2-methyl- | | 2-methyl- | |
| 1-Pentadecene | 7.94 | | | | | | | | | | |
| 1-Heptadecene | 6.16 | | | | | | | | | | |
| 1-Nonadecene | 5.39 | | | | | | | | | | |
| 1-Nonadecene | 5.13 | | | | | | | | | | |
| 1-Nonadecene | 4.17 | | | | | | | | | | |

No aromatics were produced over pure carbon blacks. Instead products were mainly linear hydrocarbon molecules. Pure ZSM-5 could not be efficiently heated up at low power MW and was unable to initiate the catalysis. At the high power of 1500 W ZSM-5 is able to heat up to the required temperature (220-350° C.) and drive the catalytic reactions. The main products of pure ZSM-5 is aromatics (Table 7).

### Example 5—Polyethylene (PE) Upcycling Using a 5:95 Carbon Black/ZSM-5 Catalyst Compositions with Zeolite with Various Si:Al Ratios

0.3 g of PE powder (purchased from Sigma-Aldrich) was physically mixed with 0.15 g of one of the various CBs/ZSM-5 catalyst composition where the CB:ZSM-5 ratio was 5:95 and where the ZSM-5 was chosen in order to have a Si:Al ratio of 18, 21, 60 or 117 (purchased from Zeolyst International). Each sample was then exposed to microwave radiation for 10 minutes at an input power of 150 W.

The liquid yields of each samples are between 79% to 84% relative to mass of PE and the selectivity to BTX is between 64% to 71% amongst the total liquid products for each sample.

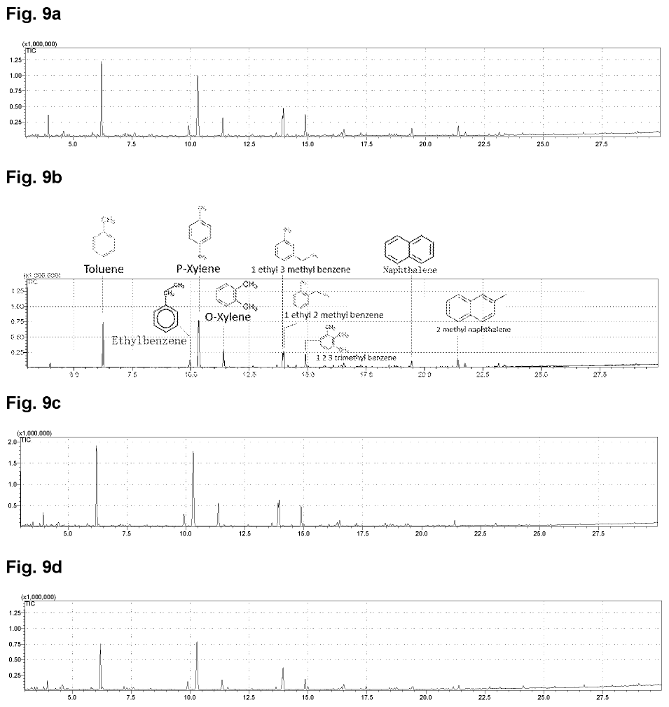

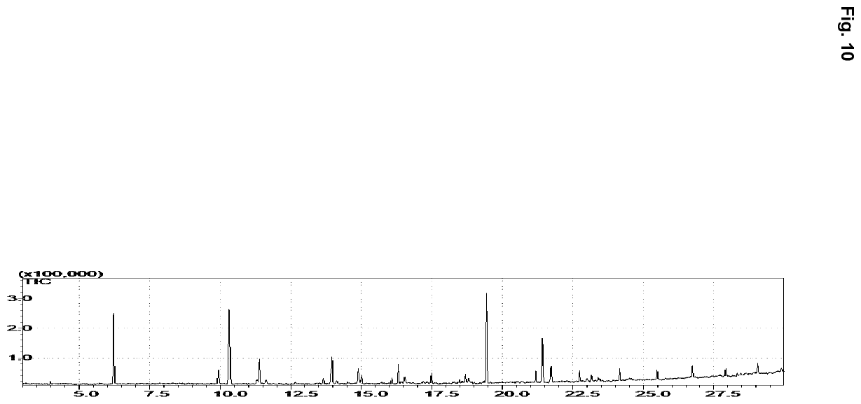

FIGS. 9a-9d show the GC-MS total ion chromatogram (TIC) of the liquid products for each of the different catalyst composition used. Table 8 shows the relative concentration of aromatics in the liquid products for each catalyst composition by GC-MS TIC.

TABLE 8

| Si/Al = 18 | | Si/Al = 21 | | Si/Al = 60 | | Si/Al = 117 | |
|---|---|---|---|---|---|---|---|
| | Concentration | | Concentration | | Concentration | | Concentration |
| Compounds | (%) | Compounds | (%) | Compounds | (%) | Compounds | (%) |
| Benzene | 5.27 | Toluene | 21.78 | Cyclopentane, | 0.97 | Benzene | 3.14 |
| | | | | methyl- | | | |
| Toluene | 23.94 | Ethylbenzene | 4.41 | Benzene | 2.96 | Cyclopropane, | 3.13 |
| | | | | | | trimethylmethylene- | |
| Ethylbenzene | 4.55 | p-Xylene | 35.83 | 1,4-Pentadiene, | 1.27 | Toluene | 20.79 |
| | | | | 3,3-dimethyl- | | | |
| Benzene, | 32.18 | o-Xylene | 10.07 | Toluene | 23.52 | Cyclohexene, | 1.2 |
| 1,3-dimethyl- | | | | | | 3-methyl- | |
| o-Xylene | 6.89 | Benzene, 1- | 6.32 | Ethylbenzene | 4.59 | Octane | 1.42 |
| | | ethyl-3-methyl- | | | | | |
| Benzene, 1- | 6.24 | Benzene, 1- | 7.34 | Benzene, | 36.43 | Ethylbenzene | 4.51 |
| ethyl-3-methyl- | | ethyl-2-methyl- | | 1,3-dimethyl- | | | |
| Benzene, 1- | 8.83 | Benzene, 1,2,3- | 5.72 | o-Xylene | 7.73 | Benzene, | 34.58 |
| ethyl-2-methyl- | | trimethyl- | | | | 1,3-dimethyl- | |
| Benzene, 1,3,5- | 6.36 | Naphthalene | 2.88 | Benzene, 1- | 6.38 | o-Xylene | 5.25 |
| trimethyl- | | | | ethyl-3-methyl- | | | |
| Naphthalene | 2.85 | Naphthalene, | 4.04 | Benzene, 1- | 7.21 | Benzene, | 1.13 |
| | | 2-methyl- | | ethyl-2-methyl- | | propyl- | |
| Naphthalene, | 2.89 | Naphthalene, | 1.61 | Benzene, 1,3,5- | 5.56 | Benzene, | 4.44 |
| 2-methyl- | | 2-methyl- | | trimethyl- | | 1-ethyl-3-methyl- | |
| | | | | Benzene, 1- | 2.11 | Benzene, | 9.78 |
| | | | | methyl-4-propyl- | | 1-ethyl-2-methyl- | |
| | | | | Naphthalene, | 1.27 | Benzene, | 4.16 |
| | | | | 2-methyl- | | 1,3,5-trimethyl- | |
| | | | | | | Benzene, | 3.25 |
| | | | | | | 1-methyl-3-propyl- | |
| | | | | | | Dodecane | 1.84 |
| | | | | | | Naphthalene, 2-methyl- | 1.38 |

### Example 6—Polyethylene (PE) Upcycling Using a Carbon Nanotubes (CNT)/ZSM-5 Catalyst Composition with 1:1 Ratio of PE and Catalyst

0.3 g of PE powder (purchased from Sigma-Aldrich) was physically mixed with 0.3 g of CNT/ZSM-5 catalyst composition (carbon nanotube were purchased from Sigma-Aldrich, and ZSM-5 was purchased from Zeolyst International) where the CNT:ZSM-5 ratio was 50:50. The sample was then exposed to microwave radiation for 10 minutes at an input power of 100 W.

About 150 ml of gases were collected. The liquid yield was 53% relative to mass of PE and the selectivity to BTX was 46% amongst the total liquid products.

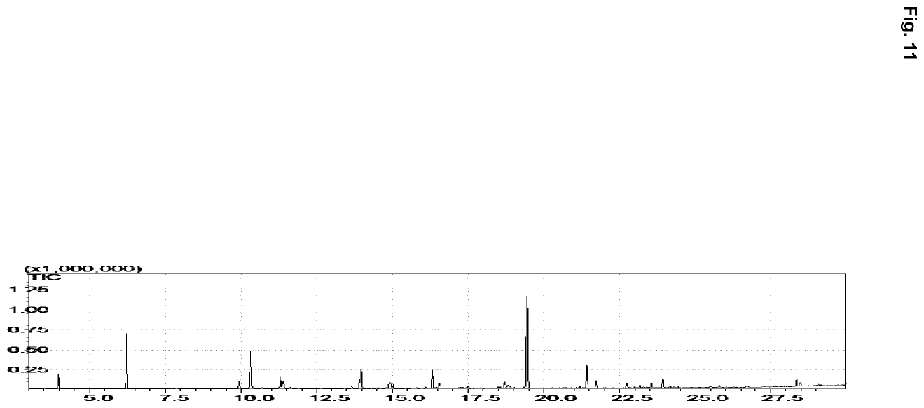

FIG. 10 shows the GC-MS total ion chromatogram (TIC) of the liquid products from PE over the 50:50 CNT/ZSM-5 catalyst composition and Table 9 shows the relative concentration of aromatics in the liquid products by GC-MS TIC.

TABLE 9

| Compounds | Concentration (%) |
|---|---|
| p-Xylene | 22.92 |
| Naphthalene | 18.32 |
| Toluene | 13.3 |
| Naphthalene, 2-methyl- | 7.91 |
| o-Xylene | 5.04 |
| Benzene, 1-ethyl-2-methyl- | 4.72 |
| Indene | 3.41 |
| Ethylbenzene | 3.2 |
| Naphthalene, 2-methyl- | 2.68 |
| Benzene, 1,2,3-trimethyl- | 2.64 |
| Benzene, 1-ethyl-2-methyl- | 2.3 |
| Eicosane | 1.77 |
| Pentadecane | 1.71 |
| Heptadecane | 1.69 |
| Tridecane | 1.66 |
| Tetradecane | 1.59 |
| Undecane | 1.44 |
| 2-Methylindene | 1.31 |
| Hexadecane | 1.27 |
| Heneicosane | 1.12 |

### Example 7—Polyethylene (PE) Upcycling Using a Molybdenum Carbide (Mo₂C)/ZSM-5 Catalyst Composition with 1:1 Ratio of PE and Catalyst

0.3 g of PE powder (purchased from Sigma-Aldrich) was physically mixed with 0.3 g of Mo₂C/ZSM-5 catalyst composition (Mo₂C powder was purchased from Fischer Scientific, ZSM-5 was purchased from Zeolyst International) where the Mo₂C:ZSM-5 ratio was 50:50. The sample was then exposed to microwave radiation for 10 minutes at an input power of 1000 W.

The liquid yield was about 55% relative to mass of PE and the selectivity to BTX was 35% amongst the total liquid products

FIG. 11 shows the GC-MS total ion chromatogram (TIC) of the liquid products from PE over the 50:50 Mo₂C/ZSM-5 catalyst composition and Table 10 shows the relative concentration of aromatics in the liquid products by GC-MS TIC.

TABLE 10

| Compounds | Concentration (%) |
|---|---|
| Naphthalene | 23.88 |
| p-Xylene | 15.61 |
| Toluene | 14.19 |
| Benzene, 1-ethyl-2-methyl- | 6.26 |
| Naphthalene, 2-methyl- | 5.95 |
| Indene | 4.31 |
| Styrene | 4.18 |
| Phenanthrene | 3.01 |
| Benzene | 2.83 |
| Biphenylene | 2.54 |
| Ethylbenzene | 2.53 |
| Benzene, 1-ethenyl-2-methyl- | 2.32 |
| o-Xylene | 2.31 |
| Naphthalene, 2-methyl- | 1.97 |
| Benzene, 1-methyl-4-propyl- | 1.61 |
| 2-Methylindene | 1.47 |
| Benzene, 1-ethenyl-2-methyl- | 1.44 |
| Biphenyl | 1.28 |
| Naphthalene, 2-ethenyl- | 1.16 |
| Phenanthrene | 1.15 |

### Example 8—Polyethylene (PE) Upcycling Using a Chromium Carbide (Cr₃C₂)/ZSM-5 Catalyst Composition with 1:1 Ratio of PE and Catalyst

0.3 g of PE powder (purchased from Sigma-Aldrich) was physically mixed with 0.3 g of Cr₃C₂/ZSM-5 catalyst composition (Cr₃C₂ powder was purchased from Fischer Scientific, ZSM-5 was purchased from Zeolyst International) where the Cr₃C₂:ZSM-5 ratio was 50:50. The sample was then exposed to microwave radiation for 10 minutes at an input power of 1000 W.

The liquid yields was about 57% relative to mass of PE and the selectivity to BTX was 17% amongst the total liquid products.

FIG. 12 shows the GC-MS total ion chromatogram (TIC) of the liquid products from PE over the 50:50 Cr₃C₂/ZSM-5 catalyst composition and Table 11 shows the relative concentration of aromatics in the liquid products by GC-MS TIC.

TABLE 11

| Compounds | Concentration (%) |
|---|---|
| Naphthalene | 41.71 |
| Indene | 9.35 |
| Naphthalene, 2-methyl- | 9.57 |
| p-Xylene | 12.38 |
| Toluene | 4.76 |
| Naphthalene, 2-methyl- | 3.98 |
| Styrene | 5.61 |
| Biphenylene | 5.02 |
| Phenanthrene | 4.08 |
| 2-Methylindene | 3.54 |

### Example 9—Polyethylene (PE) Upcycling Using a 10:90 Carbon Black/ZSM-5 Catalyst Compositions with Zeolite with at Various Microwave Input Power

0.3 g of PE powder (purchased from Sigma-Aldrich) was physically mixed with 0.15 g of carbon black/ZSM-5 catalyst composition (carbon black was purchased from Alfa Aesar, and ZSM-5 was purchased from Zeolyst International) where the CBs:ZSM-5 ratio was 10:90. Each sample was then exposed to microwave radiation for 10 minutes at an input power of one of 50 W, 100 W, 150 W, 300 W or 500 W.

The liquid yield obtained at low input power of 50 W, 100 W and 150 W were between 78% to 83% relative to mass of PE and the selectivity to BTX was about 74% amongst the total liquid products. Experiments at higher input power of 300 W and 500 W resulted in higher yield of gases with the liquid yields decreased to 58% and 50.3%, respectively and the selectivity to BTX selectivity was 58.1% and 46.5%, respectively.

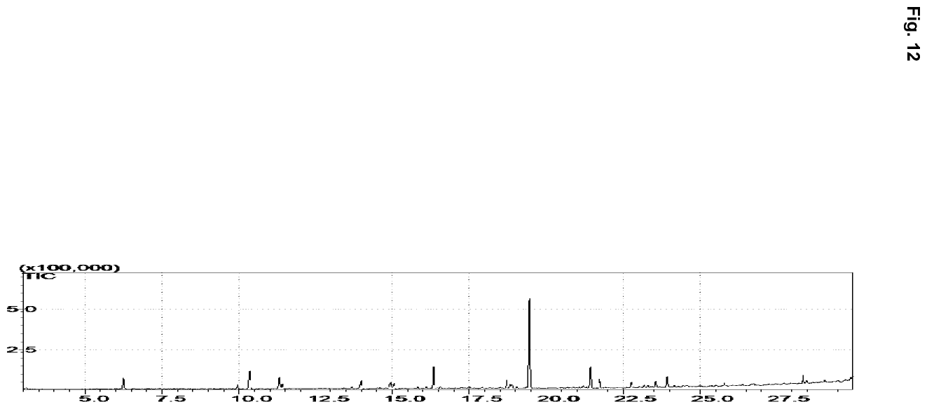

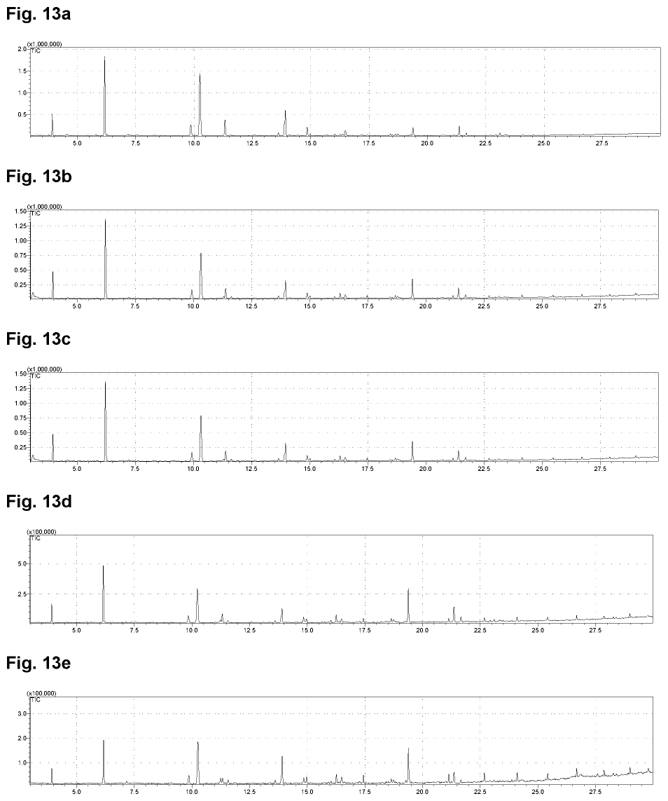

FIG. 13 shows the GC-MS total ion chromatogram (TIC) of the liquid products from PE over the 10:90 CBs/ZSM-5 catalyst composition and Table 12 shows the relative concentration of aromatics in the liquid products by GC-MS TIC.

TABLE 12

| 50 W | | 100 W | | 150 W | | 300 W | | 500 W | |
|---|---|---|---|---|---|---|---|---|---|
| | Conc | | Conc | | Conc | | Conc | | Conc |
| Compounds | (%) | Compounds | (%) | Compounds | (%) | Compounds | (%) | Compounds | (%) |
| Benzene | 5.68 | Benzene | 4.42 | Benzene | 8.04 | Benzene | 6.09 | Benzene | 4.4 |
| Toluene | 27.97 | Toluene | 29.94 | Toluene | 31.90 | Toluene | 24.52 | Toluene | 16.45 |
| Ethylbenzene | 4.5 | Ethylbenzene | 5.13 | Ethylbenzene | 4.36 | Ethylbenzene | 3.64 | p-Xylene | 25.63 |
| p-Xylene | 35.16 | Benzene, | 33.71 | Benzene, | 28.32 | p-Xylene | 23.70 | Benzene, 1- | 12 |
| | | 1,3-dimethyl- | | 1,3-dimethyl- | | | | ethyl-2-methyl- | |
| o-Xylene | 6.34 | o-Xylene | 6.48 | o-Xylene | 4.42 | p-Xylene | 3.82 | Indene | 3.22 |
| Benzene, 1- | 3.68 | Benzene, 1- | 4.36 | Benzene, 1- | 9.17 | Benzene, 1- | 1.97 | Undecane | 2.25 |
| ethyl-3-methyl- | | ethyl-3-methyl- | | ethyl-2-methyl- | | ethyl-3-methyl- | | | |
| Benzene, 1- | 8.45 | Benzene, 1- | 7.26 | Benzene, 1,2,3- | 2.13 | Benzene, 1- | 5.97 | Naphthalene | 15.86 |
| ethyl-2-methyl- | | ethyl-2-methyl- | | trimethyl- | | ethyl-2-methyl- | | | |
| Benzene, 1,3,5- | 2.52 | Benzene, 1,3,5- | 2.52 | Naphthalene | 8.01 | Benzene, 1,3,5- | 2.29 | Tridecane | 2.35 |
| trimethyl- | | trimethyl- | | | | trimethyl- | | | |
| Naphthalene | 2.67 | Naphthalene | 3.06 | Naphthalene, | 3.66 | Naphthalene | 15.67 | Naphthalene, | 3.71 |
| | | | | 2-methyl- | | | | 2-methyl- | |
| Naphthalene, | 3.03 | Naphthalene, | 3.12 | | | Naphthalene, | 6.36 | Tetradecane | 2.96 |
| 2-methyl- | | 2-methyl- | | | | 2-methyl- | | | |
| | | | | | | Naphthalene, | 1.92 | Pentadecane | 2.59 |
| | | | | | | 2-methyl- | | | |
| | | | | | | Heptadecane | 1.24 | Hexadecane | 1.96 |
| | | | | | | Heptadecane | 1.30 | Heptadecane | 2.7 |
| | | | | | | Heneicosane | 1.53 | Eicosane | 1.86 |
| | | | | | | | | Nonadecane | 2.06 |

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise paragraphed. No language in the specification should be construed as indicating any non-paragraphed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the paragraphs appended hereto as permitted by applicable law.

1. A process for producing one or more aromatic compounds comprising exposing a feed composition comprising at least one plastic to microwave radiation in the presence of a solid catalyst composition, wherein the solid catalyst composition comprises a solid acid catalyst and a carbon source.

2. A process according to claim 1 wherein the aromatic compounds comprise a mixture of benzene, toluene and xylene isomers.

3. A process according to claim 1 wherein the solid acid catalyst is a zeolite.

4. A process according to claim 3 wherein the zeolite is selected from an acidic aluminosilicate zeolite, an acidic silicon aluminium phosphate (SAPO) zeolite or a metallosillicate analogue of zeolite.

5. A process according to claim 3 wherein the zeolite is a ZSM-5 zeolite.

6. A process according to claim 3 wherein the zeolite has a Si:Al ratio about 20 to about 60.

7. A process according to claim 1 wherein the carbon source is selected from a carbon black, activated carbon, graphene, graphite, carbon nanofiber, carbon nanotube, carbon nanohorn, carbon nanoballoon, fullerene, carbides, charcoal, coal or combinations thereof.

8. A process according to claim 7 wherein the carbon source is a carbon black.

9. A process according to claim 1 wherein the carbon source is present from about 1 wt. % to about 50 wt. % of the total weight of the solid catalyst.

10. A process according to claim 1 wherein the solid catalyst composition consists of a ZSM-5 zeolite and a carbon black in a ratio of about 95:5 to about 90:10.

11. A process according to claim 1 wherein the feed composition comprises about 90% or more of one or more plastics.

12. A process according to claim 1 wherein the feed composition comprises at least one of polyethylene and polypropylene.

13. A process according to claim 1 wherein the ratio of feed composition to solid catalyst composition is about 50:1 to about 1:10.

14. A process according to claim 13 wherein the ratio of feed composition to solid catalyst composition is about 3:1 to about 1:1.

15. A process according to claim 1 wherein the process is carried out in an atmosphere substantially free of oxygen, and/or substantially free of water.

16. A solid catalyst composition comprising a solid acid catalyst in admixture with a carbon source.

17. A solid catalyst composition according to claim 16 wherein the solid acid catalyst is a zeolite.

18. A solid catalyst composition according to claim 16 wherein the carbon source is selected from a carbon black, activated carbon, graphene, graphite, carbon nanofiber, carbon nanotube, carbon nanohorn, carbon nanoballoon, fullerene, carbides, charcoal, coal or combinations thereof.

19. A solid catalyst composition according to claim 16 wherein the solid catalyst consists of a ZSM-5 zeolite and a carbon black in a ratio of about 95:5 to about 90:10.

20. Use of a solid catalyst composition according to claim 16 for upcycling plastic and/or the production of aromatic compounds.
